(19) United States
(12) Patent Application Publication
(10) Pub. No.: US 2022/0147955 A1
(43) Pub. Date: May 12, 2022

(54) SYSTEM AND METHOD FOR DIGITAL FUNDS TRANSFER AND BILL PAYMENT

(71) Applicants: Aristotelis GEORGOPOULOS, Brighton-Le-Sands, New South Wales (AU); Billi Technologies Pte. Ltd., Singapore (SG)

(72) Inventor: Aristotelis GEORGOPOULOS, Brighton-Le-Sands, New South Wales (AU)

(21) Appl. No.: 17/593,287

(22) PCT Filed: Mar. 16, 2020
(86) PCT No.: PCT/AU2020/050248

§ 371 Date: Sep. 14, 2021

(30) Foreign Application Priority Data
Mar. 14, 2019 (AU) 2019900846

(51) Int. Cl. G06Q 20/10; G06Q 20/32; G06Q 20/08

(52) U.S. Cl. CPC G06Q 20/102; G06Q 20/0855; G06Q 20/3278

(57) ABSTRACT

The present invention provides a system (7, 102, 103) for managing transfer of funds, and especially for managing payment bills and invoices, by users of the system. The system comprises: networked computing infrastructure (8, 214) including: a server or processor (8), and a database (214) of user data including user accounts for access by the respective users, wherein the networked computing infrastructure (8, 214), especially the server or processor (8), is configured to receive data relating to one or more bills or invoices associated with each user and to store particulars of each bill or invoice in the respective user account for access by that user; and at least one user computing device (1-5) for a user having an account in the database to remotely access and communicate with the networked computing infrastructure (8,214). The networked computing infrastructure (8, 214), especially the server or processor, is configured to process a payment of a bill or invoice to a respective biller from an account of the user associated with that bill or invoice upon receipt of a payment authorization from the user via the user computing device (1-5).

### TECHNICAL FIELD

The present invention relates to computer implemented programs and methods, systems, and data communication to capture, manage, and present the payment of bills and invoices, and to allow users to transfer funds and to share information securely relating to the transaction between authorised or registered users.

### BACKGROUND ART

A number of electronic bill payment systems are known. Payment system providers, such as banks and credit unions, have interfaced with ‘bill payment’ systems for many years, utilising ‘service frameworks’ such as the ‘BPay’ and ‘Post Billpay’ systems, which allow a consumer to use conventional means of payment such as the use of a credit or debit card, direct electronic transfer process or cash to effect the payment of a bill through various ‘shop fronts’ (e.g. a consumer may pay their electricity bill at the local Post Office or a web based Payments Portal) where the bills are reconciled and paid digitally.

With the advent of the Internet, electronic payment systems have been developed which allow consumers to use credit and/or debit cards to pay a bill via a web based online payments interface. The use of other payment methods have also been implemented, such as the use of intermediaries (such as PayPal) to effect the payment of a bill.

The term “electronic payment system” has come to encompass any type of electronic funds transfer system, including Point of Sale terminals in retail stores (and the associated charge card/credit card system) through to e-commerce systems—broadly, any payment system which is accessed and utilised via the Internet or a telecommunications network. Fundamentally, however, most electronic payment systems require a consumer either to attend a specific location (e.g. a Post Office) to pay a bill, or to login to one of several specific online interfaces (e.g. an online banking portal using ‘BPay view’) to pay a bill.

The technical challenge is to provide consumers new ways to pay bills and invoices in a more efficient manner. In particular, it is a challenge to reduce the time taken to process and upload the required information to the required platform and to track payment deadlines, histories, and timelines associated with the bills and invoices.

Existing solutions rely on complex sign-in processes and have high infrastructure and set-up costs, and high operating and ongoing costs. These solutions are usually only taken up by larger corporate businesses and are typically not available and/or not viable for the general public. These known systems also typically require specialised training and dedicated resources to operate which are usually not within the reach of an individual user. Furthermore, these systems are unsuitable for capturing physical (i.e. hard-copy) bills that do not have a reference number linked to a digital entry or code for capture. As such, the known systems are not designed to suit individual users and the user does not have full control of the payment process of each bill.

It would thus be desirable to provide a new and improved electronic payment system and method that is widely accessible to individuals, and that allows capture, storage, tracking and payment of bills and invoices in a variety of formats. In particular, it would be desirable to provide a payment system and method that is designed for individuals to simplify periodic and otherwise fragmented bill paying processes. It would also be desirable to provide such a payment system and method that is cost effective, easy-to-use and efficient and which may provide consolidation and tracking of paid bills.

### SUMMARY OF THE INVENTION

According to one aspect, the present invention provides a system for managing transfer of funds, preferably for managing payment of bills and invoices, by users of the system, the system comprising:

networked computing infrastructure including: a server or processor, and a database of user data including user accounts for access by the respective users, wherein the networked computing infrastructure, especially the server or processor, is configured to receive data relating to one or more bills or invoices associated with each user (e.g. as debtor or payer) and to store particulars of each bill or invoice in the respective user account for access by that user; and

at least one user computing device for a user having an account in the database to remotely access and communicate with the networked computing infrastructure;

wherein the networked computing infrastructure, especially the server or processor, is configured to effect a funds transfer or process a payment of a bill or invoice to a respective biller from an account of the user associated with that bill or invoice (e.g. as debtor or payer) upon receipt of an authorization from the user via the user computing device.

In an embodiment, each user account is configured to store an amount of funds or credit in a valid currency for payment of bills and invoices by said user via the networked computing infrastructure. To this end, each user account may be associated with a third-party bank or financial institution account of the user for transfer by the user of funds or credit into and from the user account in the networked computing infrastructure.

In an embodiment, the networked computing infrastructure is configured to enable each user of the system to communicate and interact with, and especially to conduct transactions with, any other user of the system via a respective user computing device, especially via mobile user computing devices, and especially where each of those users are individuals or natural persons. It will be appreciated, however, that any of the users may also be a legal person, such as a company.

In an embodiment, upon receipt of a command transmitted to the networked computing infrastructure by a first user of the system via a first user computing device, the networked computing infrastructure is configured to notify a second user of the system, via a second user computing device, of a request by the first user to share a bill or invoice with the second user. The request preferably identifies a share proportion of the bill or invoice nominated by the first user and is preferably to be accepted or rejected by the second user.

In an embodiment, the networked computing infrastructure is configured to transmit to a second user an invoice issued by the first user to the second user for acceptance or rejection by the second user, upon receipt of a command transmitted to the networked computing infrastructure by a first user via a first user computing device.

In an embodiment, the system is configured to effect a transfer funds from a second user to a first user upon receipt of a request from the second user for such a transfer, wherein the transfer of funds is enabled by the networked computing infrastructure when a first user computing device and a second user computing device are within a predefined proximity or distance of one another. The predefined proximity or distance is preferably less than or equal to about 20 metres, and more preferably less than or equal to about 10 metres. In this regard, the location and proximity of the first and second user devices may be calculated or determined by the networked computing infrastructure using GPS, radio frequency, sound reflection, signal strength, and/or carrier cellular triangulation.

In an embodiment, the first user computing device and the second user computing device are configured to connect with one another via wireless communication technology when they are within a predefined proximity or distance of one another. The wireless communication technology is preferably one of Bluetooth, NFC (Near Field Communications), WiFi, or a modulated acoustic frequency.

In an embodiment, the at least one user computing device is remote from the networked computing infrastructure and comprises a desktop computer, a laptop computer, a tablet, or a mobile smartphone. The at least one user computing device is desirably a mobile computing device, such as a tablet device or a smartphone.

In an embodiment, the networked computing infrastructure is configured to receive data relating to one or more bills or invoices through at least one of the following operations or steps:

receiving an image of a bill or invoice, preferably from the at least one user computing device, wherein the data and particulars of the bill or invoice in the image are converted to digital data or text using OCR technology;

accepting a share of a bill or invoice, preferably via a request transmitted using secure information transfer (e.g. NFC reading capabilities to read a NFC chip); and

transmitting an electromagnetic or modulated acoustic link between two user computing devices of the system;

manually inputting bill or invoice data at a user computing device of the system; and/or

receiving a copy of a bill or invoice in a digital or electronic format.

According to another aspect, the present invention provides a system for transfer of funds from a first user to a second user, comprising:

a digital finance architecture including an account of the first user and an account of the second user; and a plurality of mobile computational devices;

wherein the first and second users are engaged with the digital finance architecture via a respective one of the plurality of mobile computational devices;

wherein the mobile computational devices of the first and second users are configured to connect with one another via wireless communication technology if those mobile computational devices are sufficiently proximate one another; and

wherein a transfer of funds is enabled via the digital finance architecture when the mobile computational devices of the first and second user are sufficiently proximate one another.

In an embodiment, the digital finance architecture comprises or is embodied in computing infrastructure, comprising a server, a database of user data including user accounts, namely an account of the first user and an account of the second user, and communications hardware for communication with the plurality of mobile user computational devices. In this regard, the communications hardware may be configured for wired and/or wireless communication with the plurality of user devices. The user devices may include one or more of a laptop computer, a tablet device, and a mobile smart-phone.

In an embodiment, sufficiently proximate is a predefined distance that is less than or equal to about 15 metres, e.g. in a direct line, more preferably less than or equal to about 10 metres. Preferably, the wireless communications technology is selected from one of Bluetooth, Wi-Fi, NFC (Near Field Communications), and Modulated Sound Waves. Preferably, the location and proximity of the first user and the second user is calculated or determined by the digital finance architecture using one of GPS, radio frequency, sound reflection, signal strength.

Preferably, the first user sends a request to the second user to initiate the transfer of funds. Preferably, the second user accepts the request and selects a payment function to finalise the transfer of funds between the first user and the second user. Preferably, the transfer of funds is implemented in real time once the transfer of funds is finalised.

Preferably, the transfer of funds is only enabled if both the first user and second user are verified as authorized or registered users of the system by the digital finance architecture. The digital finance architecture may, for example, require a two- or three-step verification from the first and second user to enable or allow the transfer of funds.

Preferably, all communication with the digital finance architecture is secure. Preferably, the communication is secured using at least one of steganography, encryption and scrambling.

In an embodiment, the present invention provides:

a system for collecting billing and invoicing information of at least one bill or invoice from various source points; and

organising and storing the billing or invoicing data in a central location and giving an authorised user the ability to organise details of payment for each of the at least one bill or invoice from an integrated mobile computer interface.

Preferably, the at least one bill or invoice can be sourced from predefined accounts set by the user or already registered users/billers within the digital finance architecture.

Preferably, the system is arranged to enable definition of when the bill or invoice is to be paid and where the source of funds shall be obtained from when the bill or invoice is to be processed.

Preferably, the system is arranged to enable sharing of the bill or invoice from a first user to a second user so that the bill or invoice can be paid on behalf of the first user by the second user.

Preferably, the billing or invoicing information is arranged to be organised and structured for export to an external accounting software for external handling by tax agents or accountants.

Preferably, the system is arranged to send or request funds from a third party.

Preferably, the system includes the ability to send or request spilt payments from multiple parties.

Preferably, transactions are tracked. This allows for an easy management of funds paid and/or requests still outstanding so that one or more reminders can be sent.

In a further embodiment of the invention, the system enables the purchase and sending of rewards. Preferably, the rewards are virtual cash gift cards. Preferably, use of a reward requires an active account. Preferably, a notification will be sent when a reward has been received.

Preferably, the system is arranged to enable the transfer of funds from one device to another when the two devices are proximate each other. In this context, a payor or payee may optionally choose to cancel the funds transfer within an allocated time after the transfer while the two devices are proximate to each other. A cancellation of the transfer is accepted when the other accepts the cancellation from the payor or payee via the mobile application while the devices are proximate each other.

Preferably, the system is arranged to create multiple profiles for a user. Preferably the multiple profiles can be linked.

Preferably, the system enables the use of multiple currencies.

In a further embodiment of the present invention, there is provided a system including a platform for promoting and managing offers and reward schemes to a user. Each offer and reward type can be customised to the user's defined preference or signup request. All activities may be managed from a single integrated mobile application via a mobile smartphone or tablet device.

Preferably, the system is arranged to generate an invoice in real time upon receipt of a request or command to do so by a first user. Preferably, the invoice may be sent to a recipient second user via a request transaction process from the first user.

Preferably a notification is sent when the invoice is received by the recipient second user. Preferably a notification is sent when the invoice has been considered, e.g. accepted or rejected, by the recipient second user. The recipient second user may have the ability to make an immediate payment of the invoice outstanding, or to file the invoice within the system to be paid within a designated or expected time frame.

Preferably, the system is arranged to send, request and receive funds between users electromagnetically or acoustically linked through mobile devices which have the same system application running.

Preferably, the system is arranged to be accessed via desktop, laptop, mobile smart phone and tablet devices.

The system via a web portal interface will also give users access to user management type functions (disable or enabling user account, change user account details etc.).

In accordance with a further aspect, the present invention provides a system for collecting, storing and enabling payment of bills, including:

a networked computational device arranged to receive information relating to a bill and transfer information regarding the bill to a processor;

wherein the processor is arranged to process and store in a database information relating to the bill; and wherein the processor is arranged to pay at least a portion of the bill when instructed to by an authorised user of the networked computational device.

Preferably, the networked computational device is arranged to receive information relating to a bill through at least the following methods:

taking an image of a bill and converting the particulars of the bill captured in the image to digital text using OCR technology;

receive a copy of the bill in an electronic format;

accept a share process of attached bill via an existing application using secure information transfer (e.g. NFC reading capabilities to read a NFC chip) containing the bill particulars; and

using an electromagnetic or modulated acoustic link between devices to obtain the invoice or bill request information through manual input.

As the system can capture bills of digital and hard copy text format it is possible to capture and store essentially all a user's bills into the system. This allows a user to use only one portal to receive, manage, and pay those bills. This improves the efficiency and management of the user's ability to manage their bills. Preferably, the digital format is XRBL. As XBRL enables the capture and exchange of a variety of content, it enables the capture and exchange of many data points from a bill.

Preferably, to use the system, the registered user must nominate at least one source of finance for the system to access and provide funds from.

Preferably, the bills can be paid through the source of finance, where the source of finance is at least one of a credit facility, debit facility, reward system or fund transfer system. Preferably, the source of finance can be one or more facilities offered via the system. Alternatively, the source of finance can be one or more facilities offered via a third party organisation.

Preferably, the bill can be transferred to a second user registered with the system for payment of the bill. Preferably, selected proportions of the bill can be transferred to at least one second user registered with the system for payment of the bill. Preferably, the bill is transferred by the user providing a request to the second user with a digital link, wherein the digital link provides access to the bill for review and payment.

Preferably, the system includes a bill management system, wherein the bill management system is arranged to apply rules to selected bills received and stored. Preferably, stored bills and invoices are exportable to be managed by accounting software.

Preferably, the system includes a biller register; wherein digital bills or invoices received from a biller on the biller register are automatically stored to the system. Preferably, stored bills can be grouped according to category, due date, amount, biller, or subject matter. Preferably, bills received from an entity on the biller register are paid according to predetermined rules. To this end, a biller registered with the system can have their bill paid via direct transfer within the system. Preferably, bills received from an entity not on the biller register must be processed by the user.

Preferably, funds can be directly transferred between two or more users registered with the system within the system. As noted above, peer-to-peer transactions are preferably made by using an electromagnetic or modulated acoustic link between devices, a secure and encrypted push notification, or a Short Messaging Service (SMS).

Preferably, stored transactional data and reference data usable for an auditing process will be stored in a Distributed Ledger Database with an embedded hybrid blockchain-type framework so that the data will be immutable, transparent, and cryptographically verifiable. Preferably, all receipts from payments of bills or invoices made by a user are stored automatically and archived for that user's future reference.

According to another aspect, the present invention provides a computer program product configured for installation and operation on each of a plurality of user computing devices, such as mobile user computing devices, to communicate and interface with the digital finance architecture or networked computer infrastructure of the system of the invention. The computer program product may thus be provided as a mobile application. When installed and operated on each device, the computer program product is configured to perform one or more of the following functions or steps:

access a user account in the system;

capture an image of a bill or invoice for conversion to digital data or text; e.g. using OCR, to ascertain particulars of the bill or invoice for storage in a user account in the system;

receive a copy of a bill or invoice in a digital format and automatically extract bill data from the digital format, such as XBRL, to obtain particulars of the bill or invoice for storage in a user account in the system;

provide manual entry of particulars of a bill or invoice for storage in a user account in the system;

display bills and invoices stored in a user account in the system to a respective user;

communicate and interact with any other users of the system, especially where a user is an individual or natural person, then to communicate and interact with any other 2^{nd} users of the system, especially 2nd users who are also individuals or natural persons, including to:

send a request to a 2^{nd} user to share a bill or invoice, preferably using secure information transmission; and/or

send a notice to a 2^{nd} user regarding a transfer funds to the 2nd user, preferably using secure information transmission; and/or

accept a share of a bill or invoice requested by a 2nd user; and/or

accept a transfer funds notified by a 2^{nd} user; and/or

connect with another user device via wireless communication technology, such as Bluetooth, NFC, WiFi or a modulated acoustic frequency, when within a predefined proximity or distance; and/or

transmit a link, e.g. an electromagnetic link or modulated acoustic link, to another user device when that other device is within a predefined proximity or distance.

According to a further aspect, the invention provides a method of managing transfers of funds, especially payments of bills and invoices, by one or more users, comprising steps of:

maintaining at least one user account for each user of the system in a computing infrastructure, wherein each user account is configured to store an amount of funds or value credit in valid currency for electronic access by the respective users;

receiving data in the computing infrastructure relating to one or more bills or invoices associated with each user and storing particulars of each bill or invoice in the respective user account of the computing infrastructure for access by that user; and

enabling remote access to and communication with the computing infrastructure by each of the users via a respective user computing device for effecting transfer of funds to and/or from their respective user accounts, especially for payment of bills and invoices;

processing via the computing infrastructure a transfer of funds or a payment of a bill or invoice to a respective biller from an account of a user associated with that bill or invoice upon receipt of an authorization from that user via the user computing device.

In an embodiment, the method comprises: enabling transfer of funds or value credit by each user into and from the respective user account in the networked computing via a third-party bank or financial institution account of that user.

In an embodiment, the method comprises: enabling each user of the system to communicate and interact, and particularly conduct transactions, with any other user of the system via respective user computing devices, especially mobile user computing devices, and especially where each of those users are individuals or natural persons.

In an embodiment, the method comprises: on receipt of a command sent to the computing infrastructure from a first user via a first user computing device, notifying a second user, via a second user computing device, of a request by the first user to share a bill or invoice with the second user. The request preferably identifies a share proportion of the bill or invoice nominated by the first user, and the request is preferably to be accepted or rejected by the second user.

In an embodiment, the method comprises: on receipt of a command transmitted to the computing infrastructure by a first user via a first user computing device, transmitting to a second user an invoice issued by the first user to the second user for acceptance or rejection by the second user.

In an embodiment, the method comprises: effecting a transfer funds from a second user to a first user upon receipt of a request from the second user for such a transfer, when user computing devices of the first and second users are within a predefined proximity or distance of one another.

In an embodiment, the method comprises: connecting the first and second user computing devices with one another via wireless communication technology when they are within the predefined proximity or distance of one another, preferably via WiFi, NFC, Bluetooth, or Modulated Acoustic Frequency.

In an embodiment, the step of receiving data relating to one or more bills or invoices comprises one or more of:

receiving an image of a bill or invoice, preferably from a user computing device, wherein the data and particulars of the bill or invoice in the image are converted to digital data or text using OCR technology;

accepting a share of a bill or invoice, preferably via a request transmitted using secure information transfer (e.g. NFC reading capabilities to read a NFC chip);

transmitting an electromagnetic or modulated acoustic link between two user computing devices of the system;

manually inputting bill or invoice data at a user computing device of the system; and/or

receiving a copy of a bill or invoice in a digital or electronic format.

According to yet another aspect, the present invention provides a computer program, including one or more instructions to be executed in a computing infrastructure for implementing a system or method according to any one of the embodiments of the invention described above.

### BRIEF DESCRIPTION OF THE DRAWINGS

The above and further features of the present invention are more fully described in the following description of several non-limiting embodiments thereof. This description is included for the purposes of exemplifying the present invention. It should not be understood as a restriction on the broad summary, disclosure or description of the invention as set out above. The description is made with reference to the accompanying drawings, in which like reference signs designate like parts and in which:

FIG. 1 is schematic representation of a system for electronic transfer of funds or value in accordance with an embodiment of the invention;

FIG. 2 is a schematic representation of a system for electronic transfer of funds or value and for bill collection and consolidation according to another embodiment of the invention;

FIG. 3 is a schematic representation of the consolidation process, validation process and storage process for bills and invoices according to an embodiment of the invention;

FIG. 4 is an expanded schematic representation of different sub-systems and modules within the system according to an embodiment of the invention;

FIG. 5 is a schematic diagram illustrating a process of user registration with the system according to an embodiment of the invention;

FIG. 6 is a schematic representation of a system for electronic transfer of funds or value and bill processing and support according to a further embodiment of the invention;

FIG. 7 is a schematic representation of a method of bill or invoice processing according to one particular embodiment of the invention;

FIG. 8 is a schematic representation of a method of bill or invoice processing according to another particular embodiment of the invention;

FIG. 9 is a schematic representation of a bill sharing function of the system of FIG. 4;

FIG. 10 is a schematic representation of an invoicing processing method of the system of the present invention;

FIG. 11 is a schematic representation of the bill payment process of the system of FIG. 2 or the system of FIG. 6;

FIG. 12 is a schematic representation of a point of sale payment transaction process of the present invention;

FIG. 13 is a schematic representation exportable data sets to an external third party accounting package of the present invention;

FIG. 14 is diagrammatic presentation of a peer to peer system pairing a user to other nearby users according to an embodiment of the present invention;

FIG. 15 is a schematic representation of applications and systems interacting with system of the present invention;

FIG. 16 is a diagrammatic representation of a user using a mobile application according to an embodiment of the invention to top up their BILLI™ account from an external source (e.g. their assigned bank account) and to make a bill payment to a biller that is not a user of the system;

FIG. 17 is a diagrammatic representation of a user using the mobile application of the invention to make a bill payment with available funds in their BILLI™ account to a biller that is not a user of the system;

FIG. 18 is a diagrammatic representation of a user using the mobile application of the invention to top-up their BILLI™ account with funds obtained from an external source (e.g. their assigned bank account) and then to make a bill payment to a biller's BILLI™ account;

FIG. 19 is a diagrammatic representation of a user using the mobile application of the invention to make a bill payment with funds available in their BILLI™ account transferred to a biller's BILLI™ account;

FIG. 20 is a diagrammatic representation of a “user-linking” function of the system of the invention to conduct a peer-to-peer payment or peer-to-peer invoicing between two users of the BILLI™ system;

FIG. 21 is a diagrammatic representation of a “user-linking” function of the system of the invention to conduct a peer-to-peer payment or peer-to-peer invoicing between multiple users of the system;

FIG. 22 is another diagrammatic representation of the “user-linking” function of the system of the invention for a peer-to-peer payment or peer-to-peer invoicing between two users of the system with a subsequent withdrawal of funds by a user;

FIG. 23 is a diagrammatic representation of a “user-linking” function of the system of the invention to conduct a peer-to-peer funds transfer using a “Nearby Pay” function via a mobile application of the invention;

FIG. 24 is a diagrammatic representation of the “user-linking” function of the system of the invention to conduct peer-to-peer invoicing using the “Nearby Pay” function via the mobile application of the invention;

FIG. 25 is a diagrammatic representation of a “gift card” scheme function of the system of the invention for purchase by one system user for giving to another system user;

FIG. 26 is a diagrammatic representation of an “offers and rewards” scheme feature set within the system of the present invention; and

FIGS. 27 and 28 illustrate examples of user interface screens on a display of a mobile user computing device, such as a smartphone, in the system of the present invention.

The accompanying drawing figures are included to provide a further understanding of the present invention and are incorporated in and constitute a part of this specification. The drawings illustrate particular embodiments of the invention and together with the description serve to explain the principles of the invention. Other embodiments of the invention and many of the attendant advantages will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. It will also be understood that certain actions and/or steps in an embodiment of a method may be described or depicted in a particular order of occurrences while those skilled in the art will understand that such specificity with respect to sequence may not actually be required.

### DETAILED DESCRIPTION OF PREFERRED EMBODIMENTS

### Definitions

Before describing the system and method in more detail, it is instructive to provide some definitions that are helpful to clarify the components of the embodiment to be described with reference to the Figures. It will be understood that the definitions are provided solely to allow the reader to better understand the embodiments described herein, and are not intended to be limiting on the broader inventive concept.

BILLI™ system—a computing system that receives invoices/bills, generates invoices, processes, stores, pays bills and processes money transfers.

BILLI™ mobile application—a computing application that receives invoices/bills, generates invoices, processes, stores, pays bills and processes money transfers on a mobile tablet or smartphone device.

BILLI™ plugin/capture utility—a computing application that ‘piggy backs’ on a host client application to receives invoices/bills.

BILLI™ account—an account of a user in the BILLI™ system.

User—a person or entity registered as a user of the BILLI™ system to receive and/or pay bills and/or to instruct the transfer of bills or funds through the BILLI™ system.

2^{nd} User or second User—another person or entity registered as a user of the BILLI™ system to receive and/or pay bills and/or to receive communications or transfers, and/or who may have full or partial bill responsibility through the BILLI™ system.

Third Party—a person or entity not registered in the BILLI™ system that can receive communications to sign up with the BILLI™ system.

Near Field Communication (NFC)—a short range wireless communication method where information is held on a NFC chip and read by a NFC reader.

Nearby Pay—a method using wireless communication method like Bluetooth or Wi-Fi where users within a predefined proximity or distance from one another are identified and paired for a transactional process. It can use Modulated Acoustic Frequency to communicate with registered mobile devices of the users within close proximity, also.

Radio-Frequency Identification (RFID) Chip—a chip that stores information that can be transferred through radio waves.

Quick Response (QR) Code—a matrix barcode that stores information.

### System Overview

Broadly, the invention relates to a computing system configured to interact with one or more remote devices via a communications network and configured to receive, process and pay bills in a number of formats in addition to facilitating the transfer of funds between entities registered to the system. The system also allows for entities registered within the system to transfer or divide the responsibility for paying a bill between different registered entities. The system, in one embodiment, comprises a server including a processor and a database arranged to receive, store and manage billing information processed by the processor. The database is arranged to receive and transmit information via the communications network from the one or more remote devices.

Other aspects of the broad inventive concept relate to a corresponding method for the capture of particulars of bills in a variety of formats. The method facilitates the capture of bills in digital format, in hard copy, such as printed format or hand written format, in manually entered format, and storing the details of billers and historical information. The method also facilitates the transfer of funds or value between two or more entities registered with the system via one or more remote devices and a centralised database. This transfer can serve the purpose of paying the bill or can transfer the bill to another entity or a plurality of registered entities to divert or share the responsibility for the bill. The centralised database receives details of the bill from either the recipient of the bill (the user) or from the biller. The centralised database receives instructions to effect payment to the biller through preprogrammed rules or through direct instruction from the user or other authorised registered entity. The billing information or instructions to effect payment may be sent in the form of a data packet which includes, in part or in whole, encrypted information which provides one or more commands to the centralised database and/or the remote devices, to implement the aforementioned method. All stored transactional data and reference data used during an auditing process will be stored in a Distributed Ledger Database with an embedded hybrid blockchain-type framework so the data will be immutable, transparent, and cryptographic-ally verifiable. The database is configured and arranged to contain various types of information. In more detail, the database is arranged to hold information regarding a store of funds or value for the one or more entities.

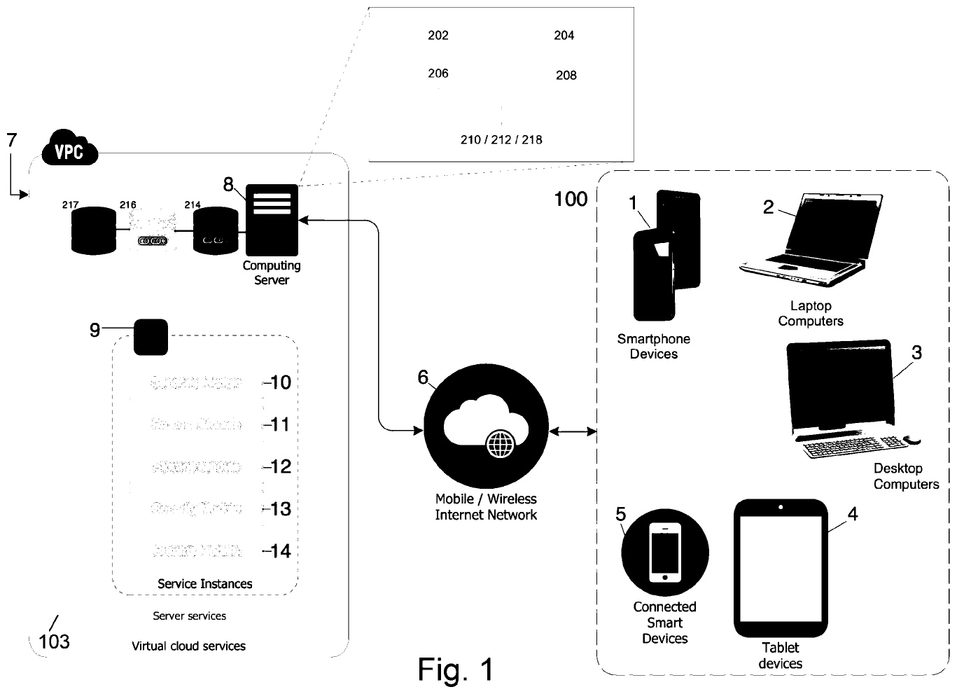

With reference to FIG. 1, there is shown a schematic diagram of a computing system 7, 103 which is provided in the form of a virtual private clound (VPC), which is capable of facilitating transactions in accordance with an embodiment of the present invention. The computing system 7 comprises a server 8 in accordance with an embodiment of the present invention. The server 8 is used to execute the operations of systems services 9, which are provided via a service module 10, a process module 11, a storage module 12, a security module 13 and a communication module 14. The computing system infrastructure 7, 103 with server 8 thus provides a system and method for facilitating the transfer of funds or value (i.e. an electronic financial transaction) according to an embodiment of the present invention.

The server 8 may comprise additional components necessary to receive, store and execute appropriate computer instructions. The components may include a processor 202, random access memory (RAM) 204, primary storage 210, an input/output devices 208 such as disc drives, as well as remote or connected devices 100 (such as a mobile smart device 5, a tablet 4, a smartphone 1, a ‘desktop’ computer 3 or a ‘laptop’ computer 2), and one or more communications link(s) 6, such as the Internet (e.g. via a mobile or wireless network).

The server 8 includes instructions that may be installed in primary storage 210, secondary storage 212, RAM 204 or storage device 218 and is executed by the processor 202. There may be provided a plurality of communication links 6, including wireless, mobile and Internet networks, which may variously connect to one or more computing devices 100, such as mobile computing communication devices like mobile (cell) telephones 1, personal computers and terminals 2, 3, or wireless or handheld computing devices 4, 5. At least one of the communications links 6 may be connected to the external computing system infrastructure 7 via a telecommunications network.

In one particular embodiment, the server 8 may include a database 214 which may reside on the secondary storage device 212. It will be understood that the database may reside on any suitable storage device, which may encompass solid state drives, hard disc drives, optical drives or magnetic tape drives. The database 214 may reside on a single physical storage device or may be spread across multiple storage devices.

The server 8 includes a suitable operating system 206 which may also reside on a storage device 218 or in the primary storage 210 and/or in the secondary storage 212 of the server 8. The operating system is arranged to interact with the database 214 and with one or more computer programs to cause the server 8 to carry out the steps, functions and/or procedures in accordance with the embodiments of the invention described herein.

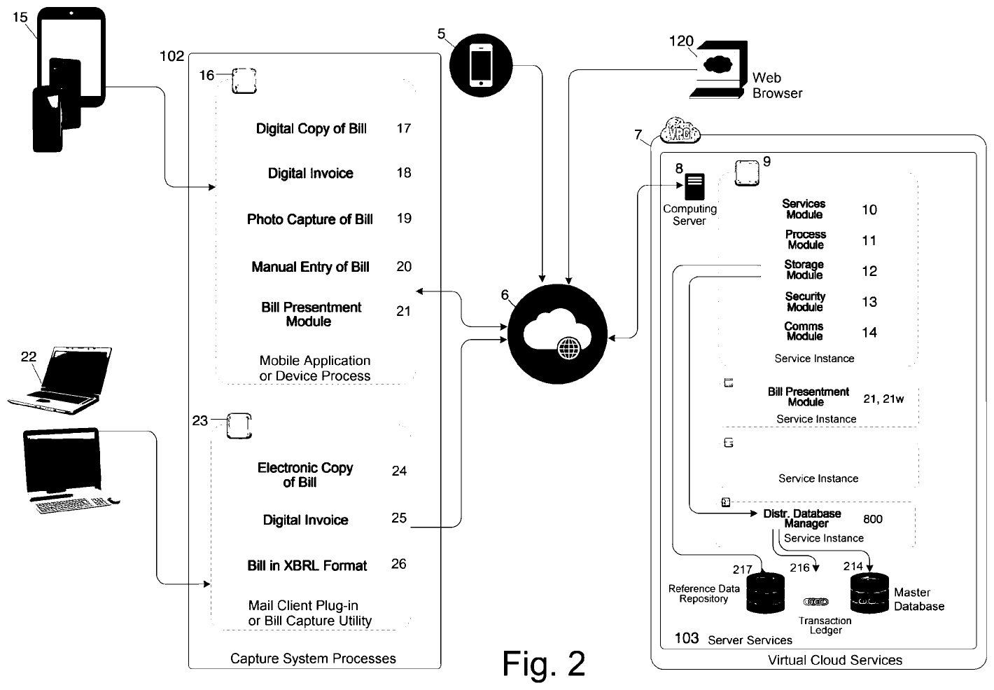

Referring now to FIG. 2, there is shown a broad schematic diagram of a system 7, 102, 103, for the capture, processing, and storage of particulars of a bill sufficient to enable payment of the bill in accordance with an embodiment of the present invention. It will be understood that in the ensuing description, the system 7, 102, 103 will also be referred to as the “BILLI™ system”.

The BILLI™ system 7, 102, 103 of this embodiment contemplates a collection/capture process 102 in two forms. The first is for use with a mobile computing devices 15, such as tablets and smart-phone devices. The BILLI™ system 102, 103 uses the BILLI™ mobile application 16 to capture, process, and receive particulars of digital bills or physical bills that are typed or hand written. Bills received via the mail client 17 can be shared to the BILLI™ mobile application 16. A second user using the BILLI™ mobile or similar application 16 can send a digital invoice via a digital invoice module 18 to the user running the BILLI™ mobile application 16. Printed bills or hand-written bills can be photo-captured via a photo-capture module 19 using the BILLI™ mobile application. Alternatively, bills can be manually entered by a user via module 20 of the BILLI™ mobile application. All captured bills are ordered, sorted, and displayed to the user by a bill presentment module 21 within the BILLI™ mobile application. All of the captured information is compressed and uploaded via an encrypted communication session to the BILLI™ backend system 7, 103 for further processing.

The second form of the collection/capture process 102 is for use with laptop and desktop computers 22. The BILLI™ system 102, 103 uses the BILLI™ plugin/capture utility 23 to receive particulars of a bill or invoice as a digital copy of bills via electronic copy module 24, as a digital invoice via a digital invoice module 25, or as XBRL format billing data files via an XBRL module 26. Bills received via the plugin/capture utility 23 are validated, compressed and uploaded via an encrypted communication session to the BILLI™ backend system 7, 103 for further processing.

At the BILLI™ backend system 7, 103, a service module 10 is used to consolidate all billing data feeds from the different types of input devices 15, 22 and capture applications 16, 23 for processing. The billing data is validated, tagged, and sorted within a process module 11. The processed data is then encrypted using a security module 13 and structured for storage by a storage module 12 into the appropriate secondary storage 217 and/or database 214. Once the bills are validated, processed, sorted and stored by the BILLI™ backend system 7, 103 and its process module 11, the billing information is then viewable on the Bill Presentment Modules 21, 21w on the BILLI™ mobile application 16 or web portal 120.

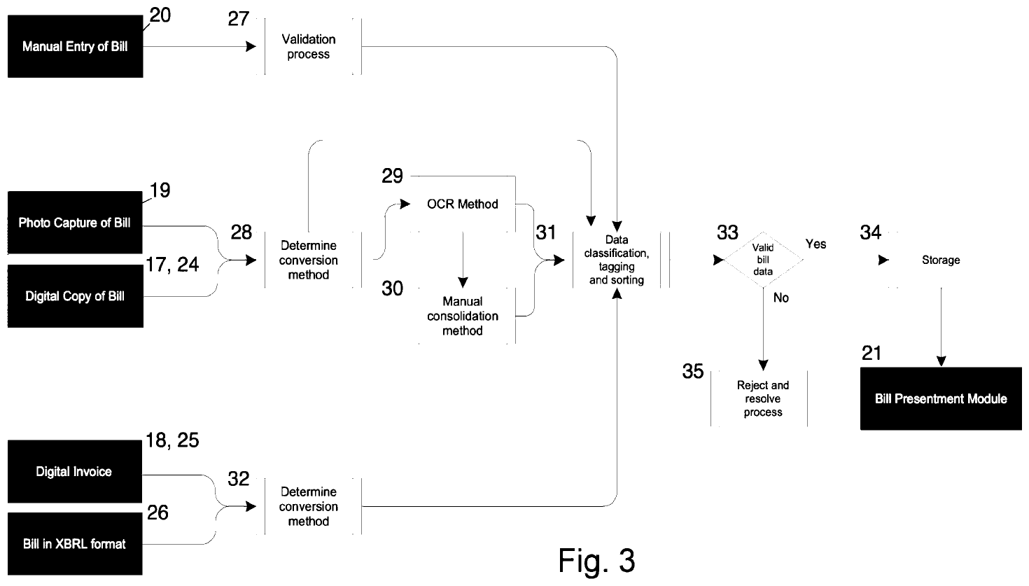

Referring now to FIG. 3, there is shown a broad schematic diagram of the system and method for capture, conversion, validation, processing, and storage of different bills consolidated via the different capture or collection modules 17-20, 24-26 and associated methods.

A manual entry of bill particulars at the manual entry module 20 via the BILLI™ mobile application 16 is validated using a pre-determined set of defined rules for the completeness of the collected billing information 27. The data is then classified, tagged and sorted in step 31 based on a set of system rules. Completeness and a recognised billing format is determined in step 33. If the billing dataset is complete and valid, it is then processed for storage by a storage module 34. If the billing dataset is incomplete or invalid, it will be rejected and a reject-and-resolve process routine 35 will be executed for a user and/or an operator to take action.

A photo-capture of bill particulars at the photo-capture module 19 via the BILLI™ mobile application 16 is validated using the following process. The captured image is assessed using the determine conversion method to assess if the resolution is sufficient for OCR (Optical Character Recognition) processing and conversion at step 29 or using a manual consolidation step 30. If the image can be processed using OCR processing and conversion, the OCR process 29 is selected. The converted data is assessed to see if a matching billing template format can be determined. If the OCR conversion process fails, the image data and converted information is tagged for a manual consolidation processing step 30. Data is extracted into the different data field sets. The data is then classified, tagged, and sorted in step 31 based on a set of system rules. Completeness and a recognised billing format is determined in step 33. If the billing dataset is complete and valid, it is then processed for storage by the storage module 34. If the billing dataset is incomplete or invalid, it will be rejected and a reject-and-resolve process routine 35 will be executed for a user and/or operator to take action.

A digital copy bill process 17, 24 via the BILLI™ mobile application 16 or BILLI™ plugin/capture utility 23 is validated using the following process. The digital billing is extracted from the host application (like an email client or attachment share feature). The digital file is assessed to see if the billing information can be extracted. If the data can be extracted, the converted data is assessed to see if a matching billing template format can be determined. If the data cannot be extracted, the process determines if OCR (Optical Character Recognition) processing and conversion 29 or using the manual consolidation method 28 should be used. If the format can be processed using OCR processing and conversion, the OCR process 29 is selected. The converted data is assessed to see if a matching billing template format can be determined. If the OCR conversion process fails, the image data and converted information is tagged for a manual consolidation processing method 30. Data is extracted into the different data field sets. The data is then classified, tagged and sorted 31 based on a set of system rules. Completeness and a recognised billing format is determined 33. If the billing dataset is complete and valid, it is then processed for storage by the storage module 34. If the billing dataset is incomplete or invalid, it will be rejected and a reject and resolve process routine 35 will be executed for a user and/or operator to take action.

It is within the scope of the present invention to allow the user to enter the particulars of the bill directly into the input device 100 when a non-electronic coded bill is unable to be OCR'd into legible digital text.

If the bill is a physical bill with no electronic coding, for example a typed or hand written bill, the bill may be photographed at step 19 and the image file converted into electronic format through an Optical Character Recognition (OCR) program. When converted to an electronic format, the bill particulars are transferred to the BILLI™ system 103 for processing and storage so they can be displayed to a user through the digital presentation module 21, 21w.

A digital invoice process via the digital invoice module 18 of BILLI™ mobile application 16 or via the digital invoice module 25 of the BILLI™ plugin/capture utility 23 is validated using the following process. The digital invoice 18, 25 is received by the BILLI™ mobile application 16 or BILLI™ plugin/capture utility 23. The conversion process 32 is determined based on the format type of the billing data and whether a matching format or valid template can be found. Data is extracted into the different data field sets. The data is then classified, tagged and sorted 31 based on a set of system rules. If the billing dataset is complete and valid, it is then processed for storage by the storage module 34. If the billing dataset is incomplete or invalid, it will be rejected and a reject-and-resolve process routine 35 will be executed for a user or operator to take action.

A XBRL format bill process 26 via the BILLI™ plugin/capture utility 23 is validated using the following process. The XBRL format bill is received by the BILLI™ plugin/capture utility 23. The conversion process 32 is determined based on the format type of the billing data and whether a matching format or valid template can be found. Data is extracted into the different data field sets. The data is then classified, tagged and sorted 31 based on a set of system rules. If the billing dataset is complete and valid, it is then processed for storage by the storage module 34. If the billing dataset is incomplete or invalid, it will be rejected and a reject-and-resolve process routine 35 will be executed for a user and/or operator to take action.

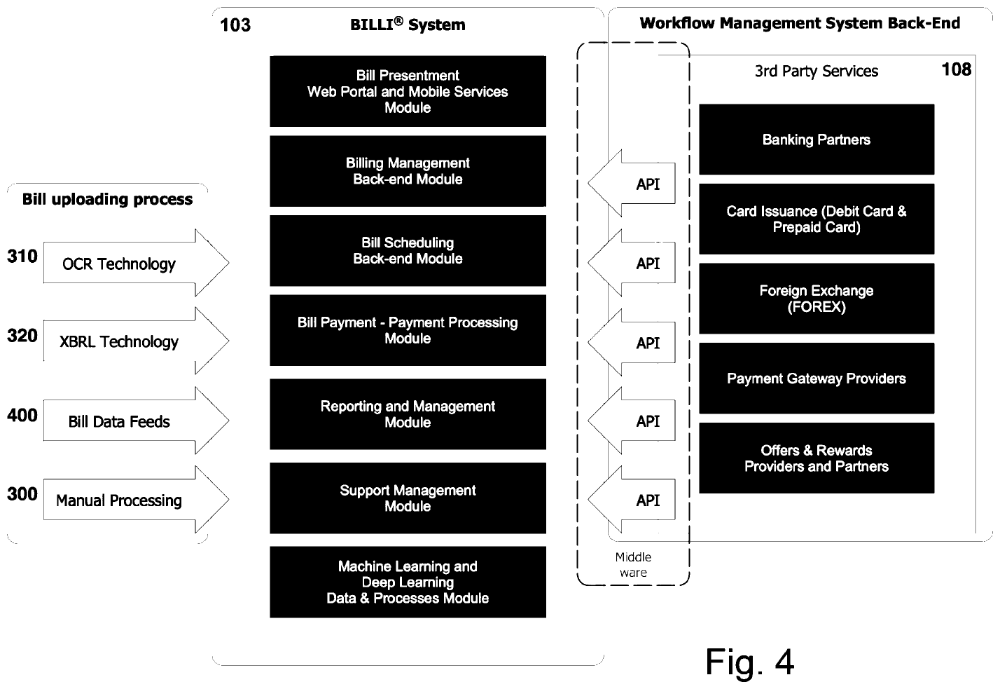

Referring to FIG. 4, a schematic illustration of the capturing process 300, 310, 320, 400 of bills onto the BILLI™ 103 system 103 is shown and the interfacing of the BILLI™ 103 system 103 with a payment management system 108 that uses sources of finance, such as external financial institution. The bill particulars can be uploaded to the BILLI™ 103 system 103 through OCR 310, directly uploaded as a digital transfer 320 using technology such as, but not being limited to, XBRL, manually entered by the user 300 or direct billing data feeds such as, but not being limited to, from a second user of a BILLI™ mobile or similar application 400. From initial registration, or later addition, the BILLI™ system 103 is linked to either banking partners and payment gateway providers to process payment or to third party services to provide the finance required to pay the bills uploaded to the BILLI™ system. Examples of these financial institutions are banking partners, debit and prepaid cards insurers, foreign exchange partners, payment gateway providers and offers and rewards providers and partners. When each bill is entered, the system 103 stores the details of the bill for later treatment.

The BILLI™ system 103 allows multiple bills to be stored, and grouped according to the manner in which a user wishes to view them. For example, the bills can be grouped in accordance to the due date of the bill. Alternatively the bills can be grouped by the amount of the subject matter to which the bills relate. The use of XBRL allows the information of the bill to be broken down and grouped as noted above.

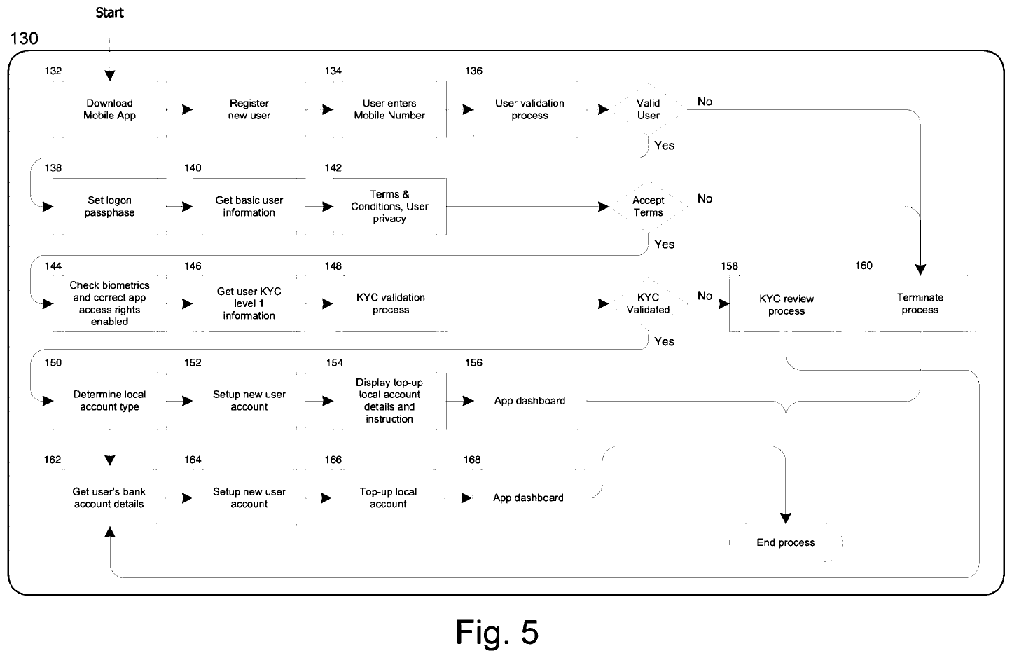

Referring to FIG. 5, a registration process 130 is shown for a user to register with the BILLI™ system 103. At step 132 a user accesses the BILLI™ software application through a mobile smartphone, tablet, or device 100 and enters mobile number details at step 134 that are used to test that the user is active through the nominated mobile number. At Step 136 a verifying SMS or notification containing a verification code (e.g. 6 or 8 digits) is sent to the nominated mobile number. Entering this verification code via the BILLI™ mobile application 16 at step 136 correctly will then enable the user to continue with the registration process. At step 138 the user sets their logon passphrase or password and at step 140 the user fills out the fields of the registration form required for registration. These fields include, for example, full name, date of birth, postal addresses, contactable email address and security question and answer sets for two factor authentication. The user will then be prompted to the various privacy provisions and the terms and conditions of use in step 142. Once these terms are acknowledged and accepted, the user will be required to setup or enable device biometrics to the BILLI™ mobile application 16 in step 144.

With further reference to FIG. 5, the user registering to use the BILLI™ system 103 will be required in step 146 to enter KYC (Know Your Customer) information depending on the financial institutions partnered for the services. In step 148 the details of the fields collected are verified against a trusted sources, such as certified KYC registers. If the details check out without issues in step 150, the type of local account to be created will be determined. If the default type of account is to be setup, the BILLI™ system 103 will allocate a new user's BILLI™ account to be created by the BILLI™ system in step 152. Following in step 154, details of the local account will then be displayed to the user with information on how the user can to top-up the account via external financial institutions. The completed process will end by navigating the user to a default home screen of a dashboard 156 of the BILLI™ mobile application. If an alternative top-up method is available, in step 162 the user will be required to enter valid bank account details and supporting information so as to be able to top-up the local virtual account. Once successful collection of this information is obtained, the new user's BILLI™ account will be created by the BILLI™ system in step 164. The BILLI™ mobile application 16 will then ask the user to enter the amount of an initial top-up value in step 166 where the system will then proceed to process this amount to be debited from their assigned bank account obtained in step 162 so that this value will be available in the BILLI™ virtual account. The completed registration process 130 will end by navigating the user to the default home screen of the BILLI™ mobile application's dashboard at step 168. If, in the event where the user's collected details fail the KYC validation process 148, it will be passed onto a KYC review process 158 where addition information will be required or direct interaction with the user will be engaged to obtain the required information prior to the creation of the account.

When the BILLI™ user account is created at step 152, the user will have the opportunity to define naming of the current profile. Once the first KYC validated account is successfully created, the user will also be able to add additional profile accounts and link this to a different bank account to classify for private, business or other defined uses. If at any stage of the on-boarding process valid requirements are not met from the user, the process will end in a termination process 160 and no BILLI™ user account will be created. With the BILLI™ user account created, the bill capturing modules 17, 18, 19, 20 via the BILLI™ mobile application 16 can be used. The user can also use the mail client plug-in 23 or bill capture utility 23 to define rules to capture and track incoming bills via the different modules 24, 25, 26 so that they can be automatically uploaded into the BILLI™ system 103 for processing. With the BILLI™ user account created, the bill capturing modules 17, 18, 19, 20 via the BILLI™ mobile application 16 can be used. The user can also use the mail client plug-in or bill capture utility 23 to define rules to capture and track incoming bills via the different modules 24, 25, 26 so that they can be automatically uploaded into the BILLI™ system 103 for processing.

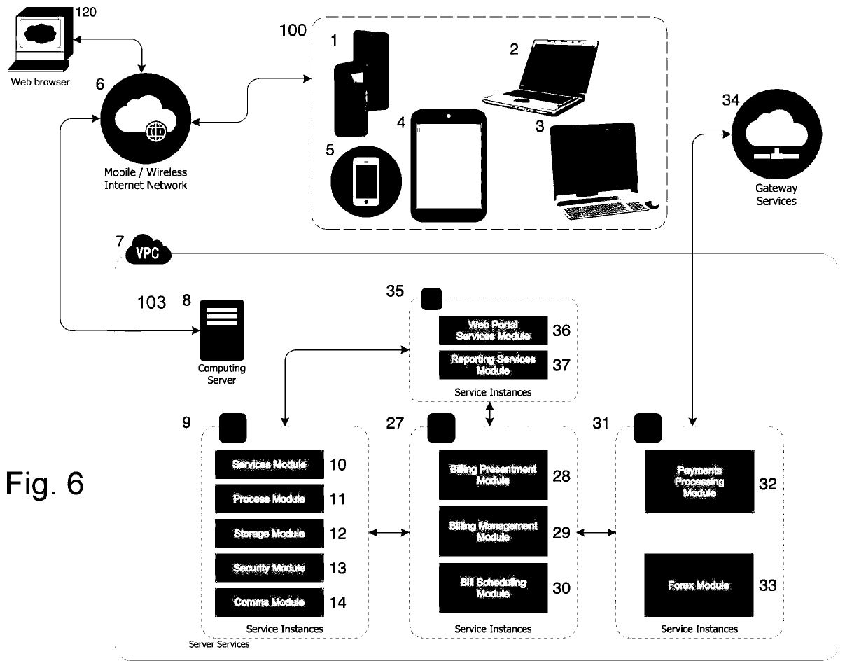

FIG. 6 shows a further embodiment of the BILLI™ system 7, 103 for electronic transfer of funds and bill and invoice processing and support. In this embodiment, the system 7, 103 can be seen to incorporate a wider variety of service instances or service utilities 9, 27, 31, 35 with their respective groups of functional modules. These modules include a service module 10, a process module 11, a storage module 12, a security module 13 and a communication module 14, also present in the embodiments of the system 103 in FIGS. 1 and 2. In addition, however, they include a bill presentment module 28, billing management module 29 for managing bill payments, and bill scheduling module 30 for scheduling bill payments. Furthermore, they include a payments processing module 32 for processing any payments or funds transfers made and a foreign exchange (forex) module 33 for processing payments or transfers from and into foreign currencies. They also include a web portal services module 36 for establishing a secure Internet/web portal and a reporting services module 37.

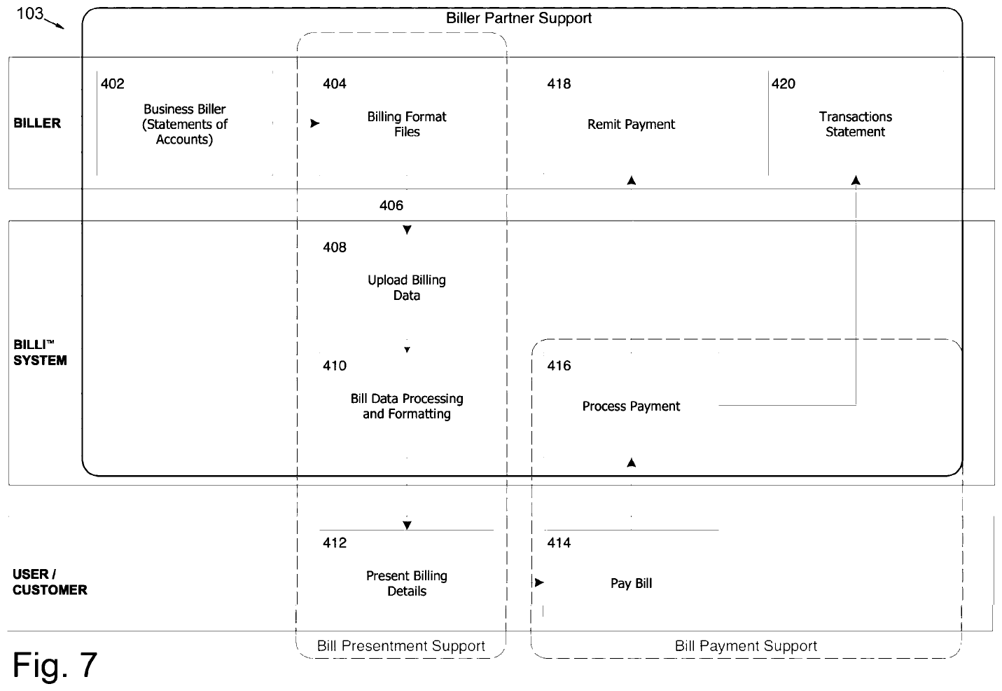

Referring to FIG. 7, the steps of the BILLI™ system 103 involved with a digital upload and payment of a bill are illustrated where the Biller has been registered by the user or already predefined within the system. Where a Biller sends a digital bill and they are registered by the user into the user's BILLI™ account, the Biller issues the bill 402. The issued bill 402 is transferred at transfer step 404 to the BILLI™ system 103 through digital transfer 406 to have the bill and its details uploaded as bill record 408.

The user can enter the BILLI™ system 103 and view the bill at viewing step 412 via the BILLI™ mobile application 16. The user can pay the bill through a nominated account at payment instruction step 414. Alternatively, if the billing management module 29 (shown in FIG. 6) of the BILLI™ system is setup to automatically pay bills, the Bill Presentment Support transfers the bill to payment instruction step 414. The BILLI™ system will process the payment instruction 414 at processing step 416 and the bill is paid to the bill issuer or nominated party at remittance step 418. After the bill is paid, a record of the payment 420 is sent to the biller and stored and archived in the system.

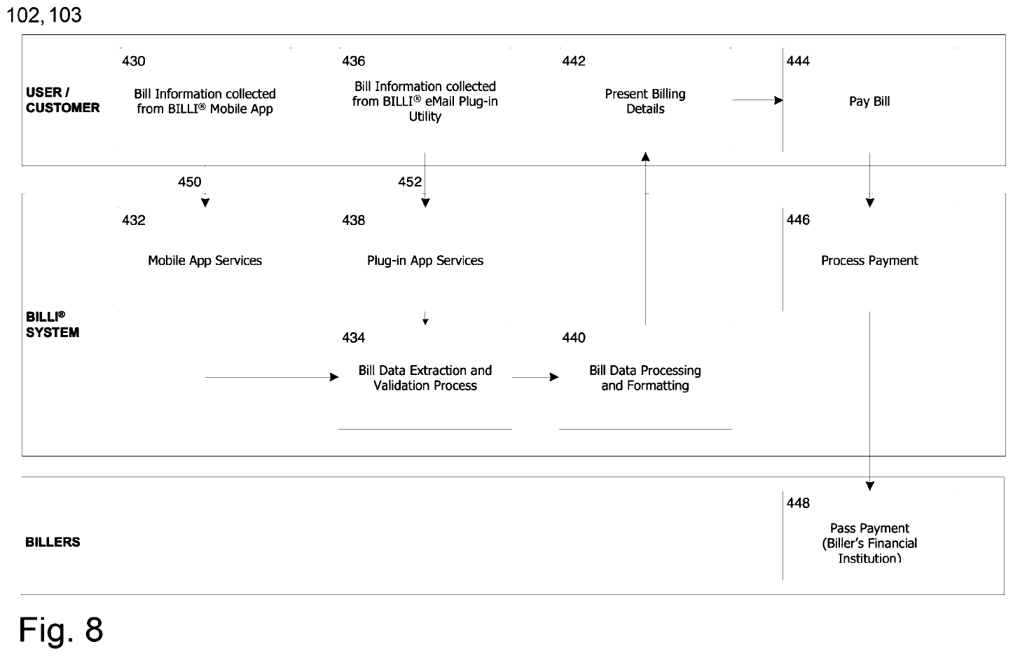

Referring to FIG. 8, the steps involved with an upload and payment of a bill where the Biller is not registered with the user in the BILLI™ system 103. The Biller sends the bill which can be collected at either two entry points. If the bill is assigned by the user from BILLI™ mobile application 16, the bill is obtained via process 430 using the BILLI™ mobile application 16. This can be in a digital, hard copy format or manual entry. The BILLI™ mobile application uploads the bill at step 450 via the collection services module 432. Using OCR extraction techniques 434 or other digital data extraction techniques 434 the data is extracted into usable fields where it can be represented for bill presentment. The bill is processed by the computing system and stored at processing step 440.

If the bill is collected using the BILLI™ plugin/capture utility 23, the bill is obtained via process 436 using the BILLI™ plugin/capture utility 23. The BILLI™ plugin/capture utility uploads the bill at step 452 via the collection services module 438. Using OCR extraction techniques 434 or other digital data extraction techniques 434 the data is extracted into usable fields where it can be represented for bill presentment. The bill is processed by the computing system and stored at processing step 440.

When the user enters the BILLI™ system 103 via the BILLI™ mobile application 16, they can view the bill at viewing step 442 via the BILLI™ mobile application 16. Through the BILLI™ mobile application 16, the user can pay the bill through a nominated account at payment step 444. The BILLI™ system 103 processes the payment step at processing step 446 and the bill is paid to the Bill Issuer or nominated party at remittance step 448.

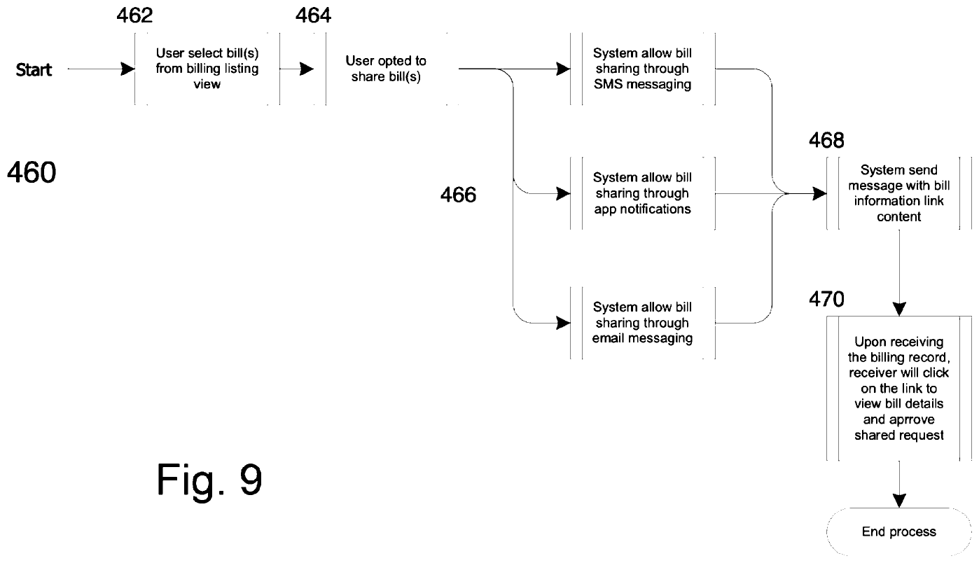

Referring to FIG. 9, a bill sharing function 460 is illustrated. A user sets up the BILLI™ system 103 via the BILLI™ mobile application 16 so that at least one 2^{nd} user registered with BILLI™ are linked to their user account. At the bill selection step 462, a bill stored in a user's BILLI™ system account is chosen by the user. The user selects an option within the BILLI™ mobile application 16 to share the bill at share selection step 464. In share selection step 464 the user elects one or more selected 2^{nd} users to share the bill with and the proportion of the bill that they wish to share with each of the selected 2nd users. The shared bill is then sent to the selected 2nd user(s) at bill sharing step 466 through SMS, application notification, email or other digital notification method and a message 468 is sent to the selected 2^{nd} users with details of the proposed sharing and means to open, consider and pay the bill. When the bill is received, the 2^{nd} user views the bill through a link in the message at bill viewing step 470. The selected portion of the bill can then be paid through the link by the selected 2^{nd} user. A notification will be sent to the user sharing the bill when the party receiving the shared bill accepts the invitation.

The bill is able to be transferred to a 2^{nd} user (i.e. another registered BILLI™ user) via email, SMS, application notification, or otherwise, via the BILLI™ system without knowledge of the first user's account details.

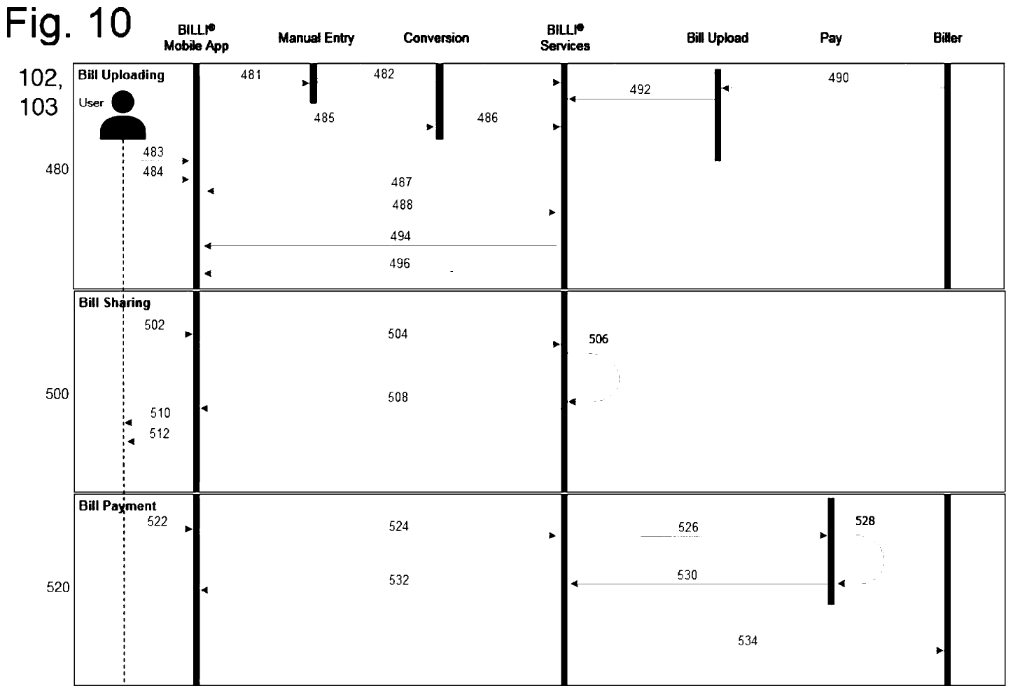

Referring to FIG. 10, bill uploading, sharing and payment options are illustrated. Bill uploading 480 where the user can submit the bill to the BILLI™ system 103 via the BILLI™ mobile application 16 by a manual entry process at step 481. The manual entry is checked at step 482 and the billing details are logged by the BILLI™ system 103. The bill can also be submitted to the BILLI™ system 103 via the BILLI™ mobile app 16 by an image capture or file transfer process 483 or via use of an email client plug-in 484. After the capture file is uploaded to the BILLI™ system 103 at step 485, a conversion and validation process or step 486 is engaged where the billing details are logged by the BILLI™ system 103. The user is notified of the conversion and submits the entry to the user for approval at step 487. The user then validates and approves the entry in step 488.

If the bill is directly entered into the system as an electronic bill from a biller registered in the BILLI™ system 103, the biller sends the electronic bill to the BILLI™ system 103 at electronic transfer step 490. The biller and bill is verified by the BILLI™ system 103 at step 492. After verification, the bill is uploaded and stored in the BILLI™ system 103 where the user will be able to be notified of the bill in step 494.

Once bills are stored digitially in the BILLI™ system 103, a user can retrieve the details or particulars of any bill in their account for their reference at step 496 via the BILLI™ mobile application 16.

Bill Sharing 500: If bill sharing is required, the user 502 selects a bill to and then sets one or more persons (i.e. the 2^{nd} user/s) to share the bill with at step 504. The bill is sent to the selected 2nd user at sharing step 506. The selected 2nd user can review and accept their allocated proportion of the bill at step 506 and the amount and status of the bill as apportioned between parties is updated at step 506. Once these steps have taken place a verification of the shared bill being sent is sent to the user at verification step 508. In step 510 the second user receives a viewable version of the bill. The 1^{st} user gets a notification that the 2^{nd} user has accepted the bill in step 512.

Bill Payment 520: When the user or a selected 2nd user wishes to pay the bill or a portion of it, they log into the BILLI™ system 103 and view the bill at bill viewing step 522. The user or selected 2^{nd} users elects to pay the bill and directs payment to the system at payment direction step 524. The system presents the payment direction to the selected payment mode at presentment step 526. The BILLI™ system 103 reviews the instructed method of payment at review step 528 and pays the bill to the biller to one of the nominated funding sources at payment step 530. The user is sent notification at step 532 and the biller is then sent a notification 534 that the payment has taken place.

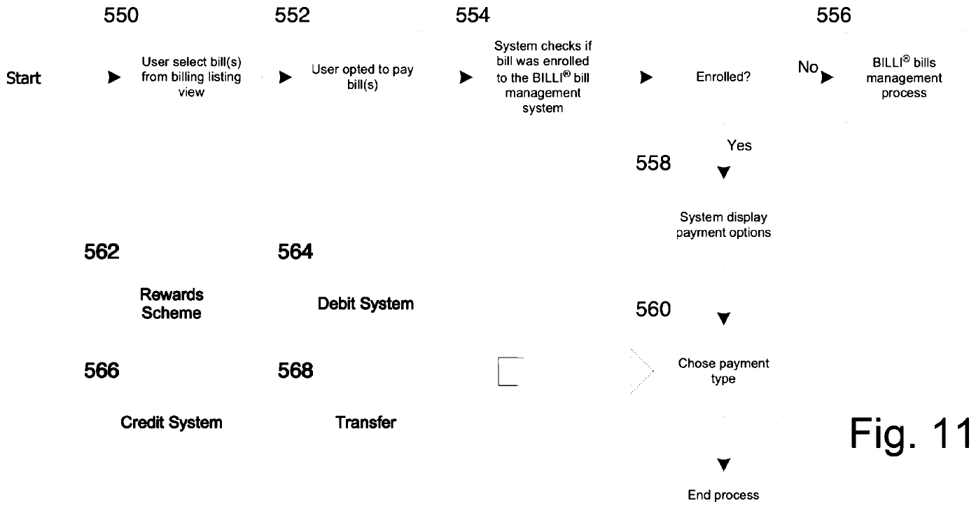

Referring to FIG. 11, an overview of the BILLI™ system 103 is shown. When the user is logged into the BILLI™ system 103 the user selects a bill stored in the system 103 at bill selection step 550. The user opts to pay the bill at payment selection step 552. The BILLI™ system 103 reviews its internal database to identify if the selected bill is registered under a bill management process at review step 554. If the bill is not registered under the bill management process, it is dealt with according to preprogrammed rules of the system at step 556. If the bill is registered under a bill management process, the system displays to the user the payments options at step 558. The user can elect to pay the bill through an internal BILLI™ payment facility 560.

If the user selects to pay using an internal BILLI™ payment facility 560 they have a number of choices. The user can elect to pay the bill through a rewards system 562, a debit system 564, a credit system 566 or can transfer 568 the bill to a 2^{nd} user biller or multiple 2^{nd} user billers who is/are a part of the BILLI™ system.

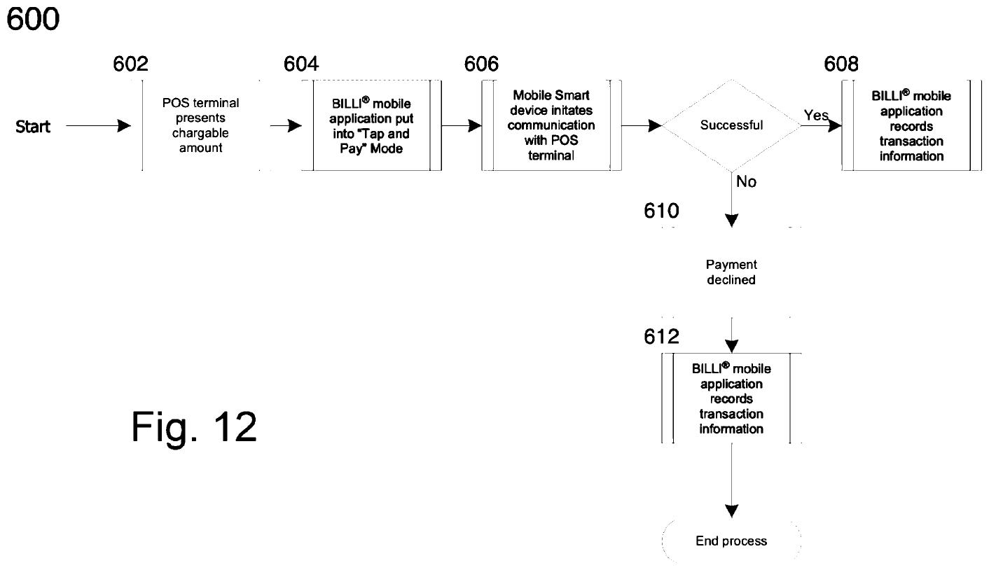

FIG. 12 shows a “Tap and Pay” function 600 of the BILLI™ mobile application 16. At a point of sale, the user can present At a point of sale, the user can present a BILLI™ Nearby Pay enabled Smart Mobile device running the BILLI™ mobile application 16 to make payment with a BILLI™ Nearby Pay enabled POS terminal. The BILLI™ POS terminal will present to the user the chargeable amount in step 602. The user will invoke the BILLI™ mobile application 16, select the account that they wish to use and put it into “Tap and Pay” mode 604. The smart mobile device is then brought within proximity of the BILLI™ Nearby Pay enabled POS terminal so that the transaction can be done in step 606. If the transaction is successful, the BILLI™ mobile application will record the transaction details and capture other metrics if necessary about the transaction in step 608. The merchant will received the funds via the POS network system. The chargeable amount will be debited from the user's selected BILLI™ account and credited to the merchant's BILLI™ account.

If the transaction is not successful as in step 610, the BILLI™ mobile application will still record the transaction details and capture other metrics if necessary about the transaction in step 612. The merchant will not receive the funds via the BILLI™ network system. No chargeable amount will be debited from the user's selected BILLI™ account. The user will need to pay via other methods.

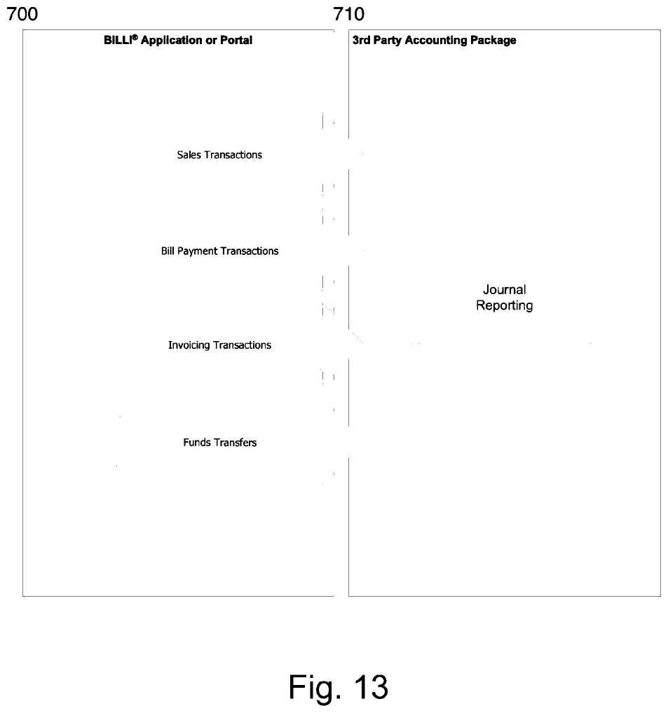

In FIG. 13, the user can use the BILLI™ system 700 to extract various types of accounting records to be used by third party accounting packages 710. Extraction of this type of information and data can be done via the BILLI™ mobile application 16 where an export feature will be available from within its menu. Extraction of the data can also be obtain via a BILLI™ user web portal using a desktop or laptop type computing device via a suitable web browser.

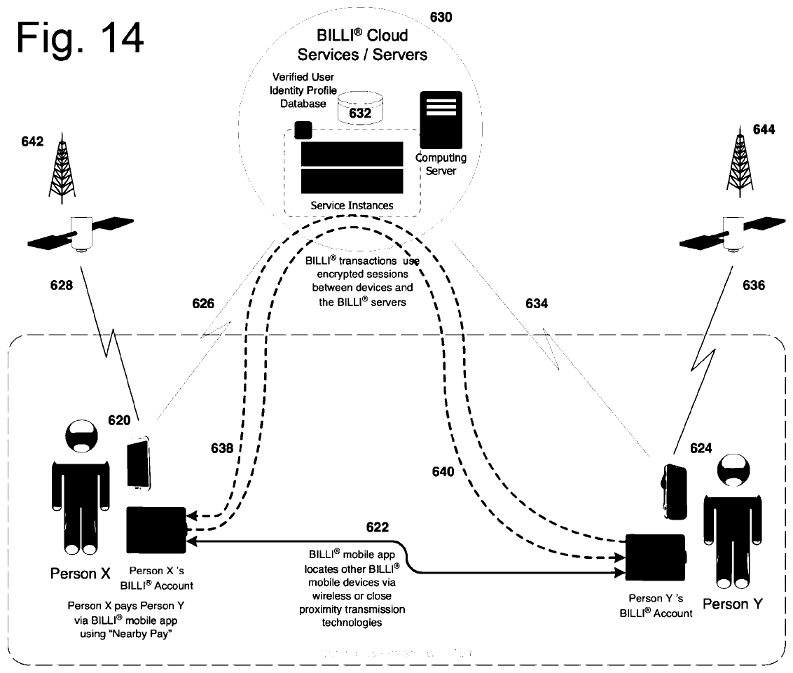

FIG. 14 shows the diagrammatic flow of how the BILLI™ system's peer-to-peer “Nearby Pay” system works to pair to other nearby BILLI™ users for easy device to device communication for transactional activities. In initiating step 620, the 1st user, person X, opens the BILLI™ mobile application 16 and invokes the “Nearby Pay” function. The user initiates a request for payment in this process. In step 622, the BILLI™ mobile application then uses wireless communication technology available on the smart device to locate another BILLI™ user via their BILLI™ mobile application 16. The wireless communication technology includes Bluetooth, Wi-Fi etc. or proprietary communications technology using Modulated Acoustic Transmission or picture imaging (e.g. QR code). In step 624, the 2nd user, person Y, opens their BILLI™ mobile application 16 and invokes the “Nearby Pay” function to accept the request and pay. The BILLI™ mobile application 16 for person Y then obtains locational information via GPS 636 or other location based services 644 to establish a secure encrypted session 634 with the BILLI™ cloud and its servers 630. The BILLI™ system ensures that person Y's mobile smart device is a valid and trusted entity by checking it's verified user identity profile database 632 before establishing a secure encrypted session 626 with person X's mobile smart device 620. The BILLI™ mobile application on person X's mobile smart device 620 then determines it's locational information via GPS 628 or other location based services 642 and determines if it's within proximity for valid transactional activity. The BILLI™ system also checks to see if person X's device is a valid and trusted entity by checking the verified user's identity profile database 632. Only after all checks are verified and cleared will the transactional information request 640 be exchanged between persons' X and Y's BILLI™ mobile smart devices via the BILLI™ mobile application 16. Only when person Y agrees to complete the payment process, will the transfer of funds between accounts be completed in step 638. The BILLI™ system 103, 630 may impose or enforce two-factor and three-factor authentication on the mobile device(s) of person X and/or of person Y via the BILLI™ mobile application 16 if further validation is required.

FIG. 15 shows the BILLI™ system 103 electronically linked to and interacting with its BILLI™ bill capture module 122, BILLI™ funds transfer module 123, point of sale module 124, BILLI™ services module 125, and BILLI™ financial reporting and journal module 126.

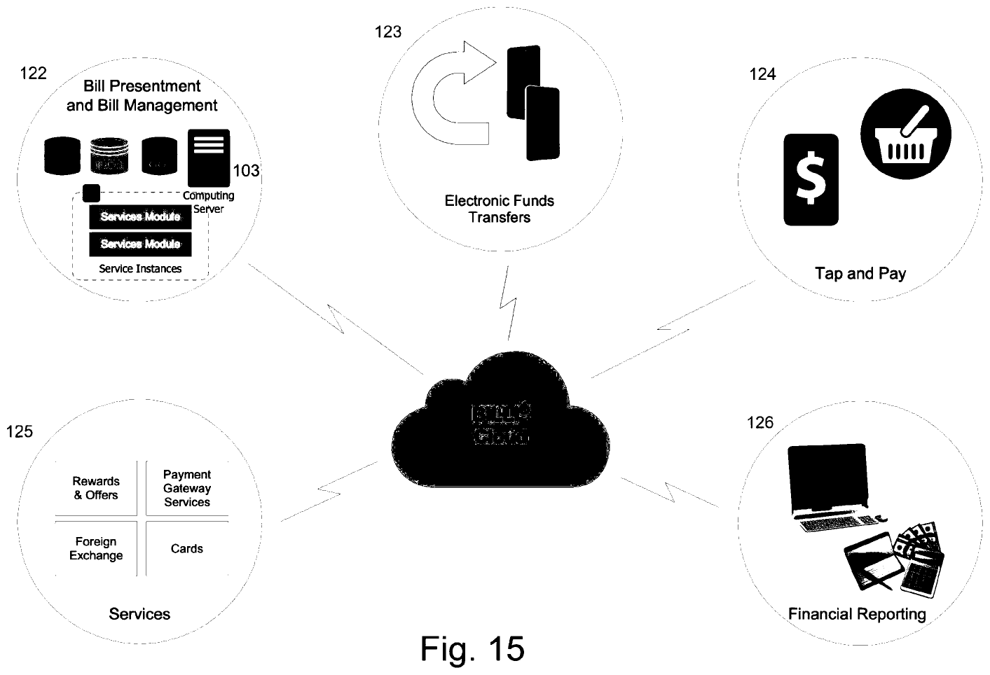

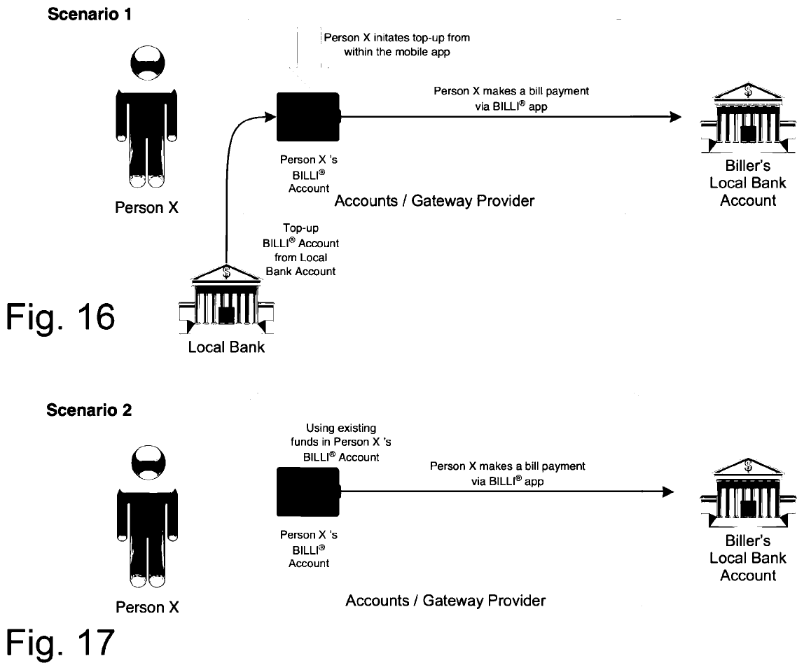

FIGS. 16 to 25 of the drawings schamtically illustrate a number of different scenarios for use of the system and method of the preferred embodiments of the invention. More particularly, drawing FIGS. 16 to 25 show a range of use scenarios for the BILLI™ system 103 and BILLI™ mobile application 16 of the preferred embodiments. The user/s in each of theses use scenarios is identified as a person (e.g. person X, Y and/or Z). Any one of these users may thus be an individual or natural person, or may also be a company or legal person on whose behalf an individual acts.

FIG. 16 illustrates a scenario (Scenario 1) in which a user (person X) uses the BILLI™ system 103 to make payments to a biller for a bill where the biller does not have a BILLI® account. Person X uses the BILLI™ mobile application 16 to top up their BILLI™ account with funds obtained from an external source (e.g. their assigned bank account) to make the bill payment. The bill payment is processed via the payment gateway system whereby funds from the BILLI™ account of person X are withdrawn and credited to the biller's bank account.

FIG. 17 illustrates a scenario (Scenario 2) in which a user (person X) uses the BILLI™ system 103 to make payments to a biller for a bill where the biller does not have a BILLI™ account. Person X uses the BILLI™ mobile application 16 to make the bill payment with funds available in their BILLI account. The bill payment is processed via the payment gateway system whereby funds from person X's BILLI™ account are withdrawn and credited to the biller's bank account.

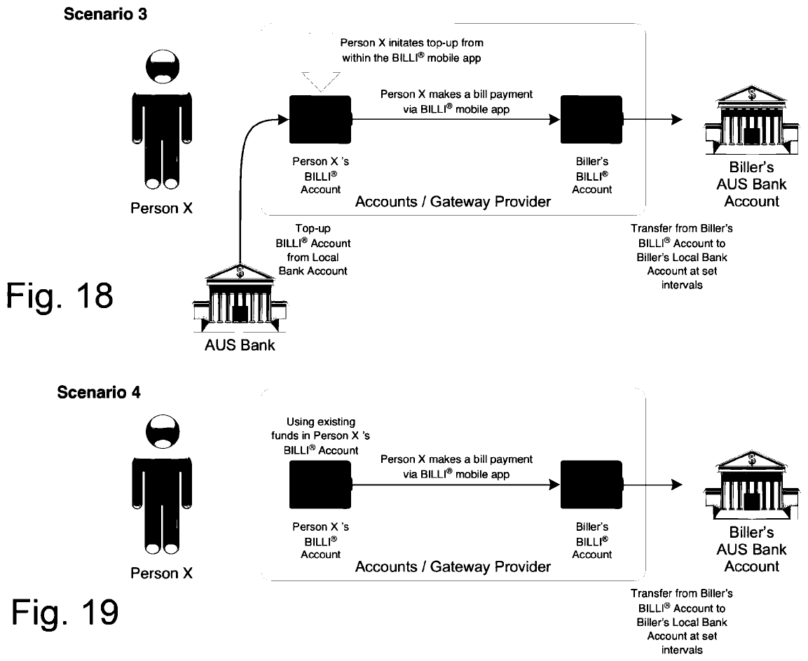

FIG. 18 illustrates a scenario (Scenario 3) in which a user (person X) uses the BILLI™ system 103 to make payments to a biller for a bill where the biller has a BILLI™ account. In this scenario, person X uses the BILLI™ mobile application 16 first to top up their BILLI™ account with funds from an external source (e.g. an assigned bank account) and then to make the bill payment. Funds for the bill payment are received in the biller's BILLI™ account. The biller then has the option to withdraw the funds from their BILLI™ account. Funds from the biller's BILLI™ account can be withdrawn and credited via the payment gateway system to an assigned bank account of the biller.

FIG. 19 illustrates a scenario (Scenario 4) in which a user (person X) uses the BILLI™ system 103 to make payments to a biller for a bill where the biller has a BILLI™ account. The user makes the bill payment using available funds from their BILLI™ account. The funds for the bill payment are received in the biller's BILLI™ account. The biller then has the option to withdraw the funds from their BILLI™ account. That is, funds from the biller's BILLI™ account can be credited via the payment gateway system to the biller's assigned bank account.

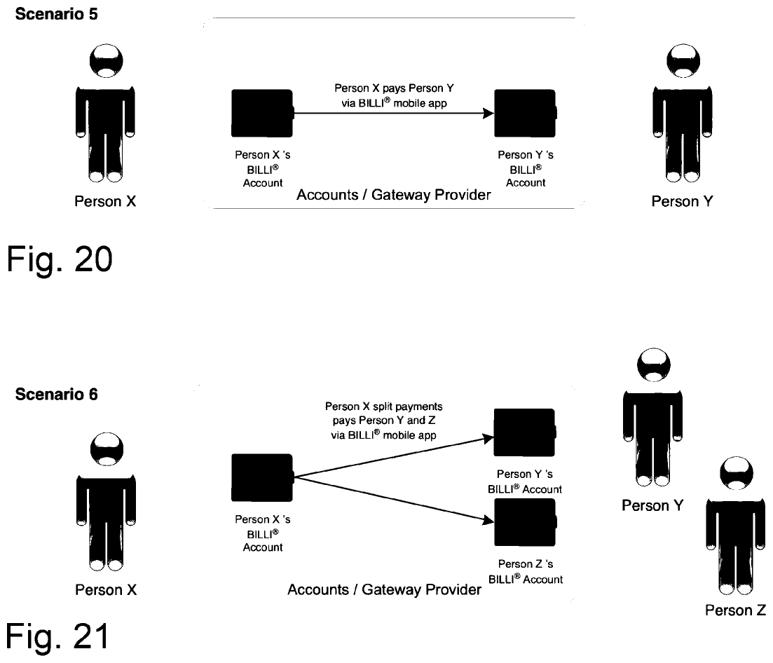

FIG. 20 illustrates a scenario (Scenario 5) in which a first user (person X) uses the BILLI™ system 103 to transfer funds from his/her BILLI™ account to the BILLI™ account of a 2nd user (person Y). The peer-to-peer transaction is made using an electromagnetic or modulated acoustic link between devices, a secure and encrypted push notification, or a Short Messaging Service (SMS). The allocated funds set up by person X are transferred via the peer-to-peer transmission method from person X's BILLI™ account to person Y's BILLI™ account.

FIG. 21 illustrates scenario (Scenario 6) in which one user (person X) uses the BILLI™ system 103 to transfer funds from their BILLI™ account to multiple other BILLI™ account users (person Y and person Z). The peer-to-peer transaction may be carried out using an electromagnetic or modulated acoustic link between devices, a secure and encrypted push notification, or a Short Messaging Service (SMS). The funds allocated by person X are transferred via the peer-to-peer transmission method from person X's BILLI™ account to person Y and Z s′ BILLI™ account in the amounts or values specified by person X.

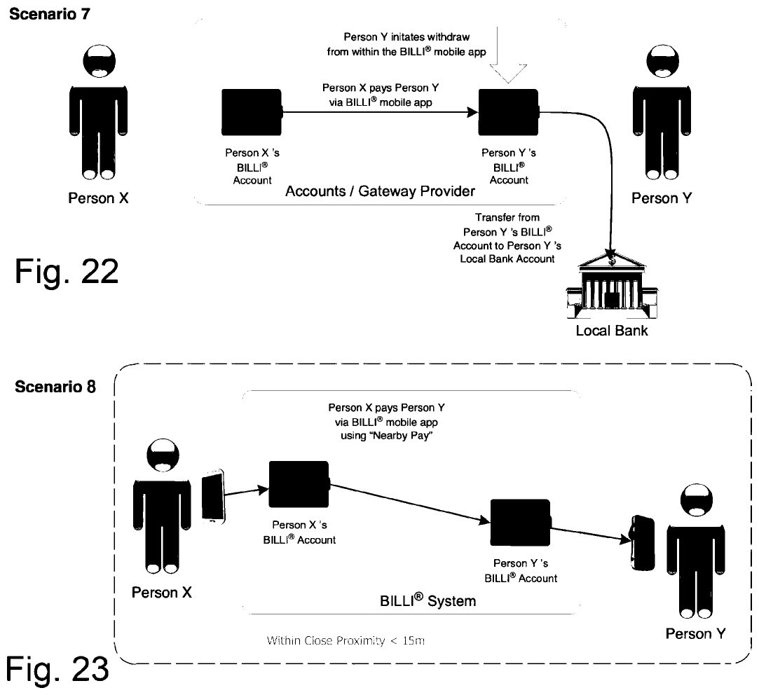

FIG. 22 illustrates a scenario (Scenario 7) in which a user (person X) uses the BILLI™ system 103 to transfer funds via a peer-to-peer payment from his/her BILLI™ account to the BILLI™ account of a 2nd user (person Y), who then initiates transfer/withdrawal of those funds. The peer-to-peer transaction may again be carried out using an electromagnetic or modulated acoustic link between devices, a secure and encrypted push notification, or a Short Messaging Service (SMS). The allocated funds of person X are transferred via the peer-to-peer transmission from person X's BILLI™ account to person Y's BILLI™ account. When the funds become available in person Y's BILLI™ account, person Y may transfer/withdraw the funds, which transfer is processed via the payment gateway system whereby funds from person Y's BILLI™ account are credited to Person Y's assigned bank account.

FIG. 23 illustrates a scenario (Scenario 8) in which a first user (person X) uses the peer-to-peer “Nearby Pay” payment method to a second user (person Y), as explained with reference to FIG. 14. The peer-to-peer transaction is preferably made using an electromagnetic or modulated acoustic link between mobile devices in close proximity. The funds allocated by person X are transferred to person Y via the peer-to-peer transmission from person X's BILLI™ account to person Y's BILLI™ account.

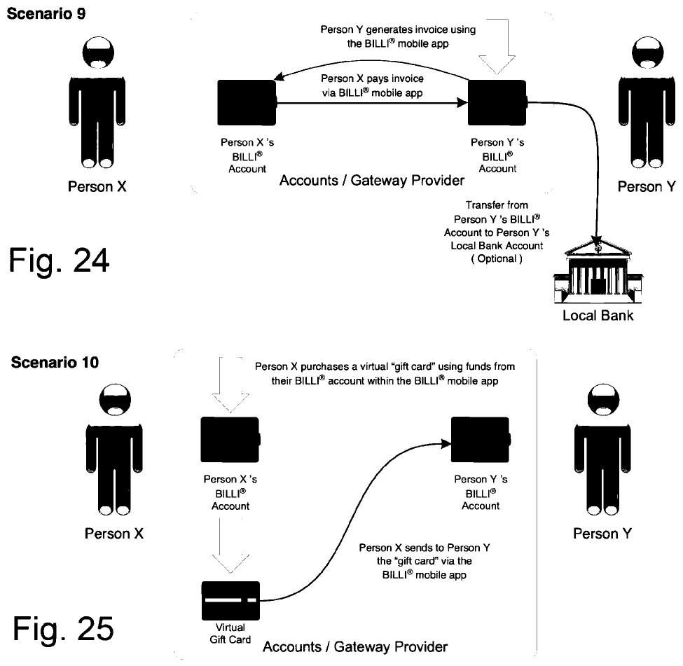

FIG. 24 illustrates a scenario (Scenario 9) in which a user (person Y) performs a peer-to-peer “Nearby Pay” invoicing procedure using the mobile application 16. The peer-to-peer request and payment procedure is made using an electromagnetic or modulated acoustic link between devices in close proximity to one another. In this regard, person Y generates an invoice and submits a request for payment to person X. Person X receives the invoice via the wireless peer-to-peer method and accepts the invoice for payment. The funds of the invoice amount are transferred from person X's BILLI™ account to person Y's BILLI™ account. Person Y may then elect to withdraw the funds. The withdrawn amount set by person Y is processed via the payment gateway system whereby funds from person Y's BILLI™ account are withdrawn and credited to person Y's assigned bank account.

FIG. 25 illustrates the scenario (Scenario 10) when user (person X) purchases a virtual gift card. Person X uses the mobile application 16 to purchase a virtual gift card of a designated value amount using funds available from person X's BILLI™ account. Person X then sends the virtual gift card to a second user (person Y) via an electromagnetic or modulated acoustic link between respective user devices, via a secure and encrypted push notification, a Short Messaging Service (SMS) or an email. When person Y receives and accepts the virtual gift card, an acceptance notification is sent to person X. Funds to the value amount of the virtual gift card are then made available to person Y in their BILLI™ account. If person Y were not an existing BILLI™ user, person Y could be contacted and asked to enrol as a user of the BILLI™ system, whereby once enrolment was complete and their account active, the virtual gift card would then made available to person Y from within their newly created BILLI™ account, e.g. via the mobile application.

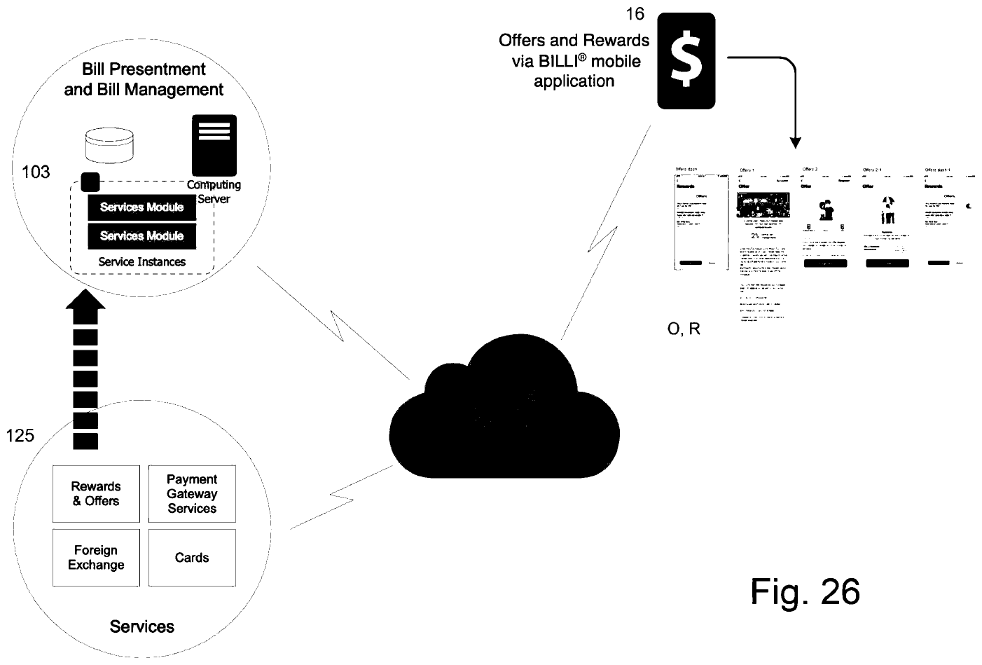

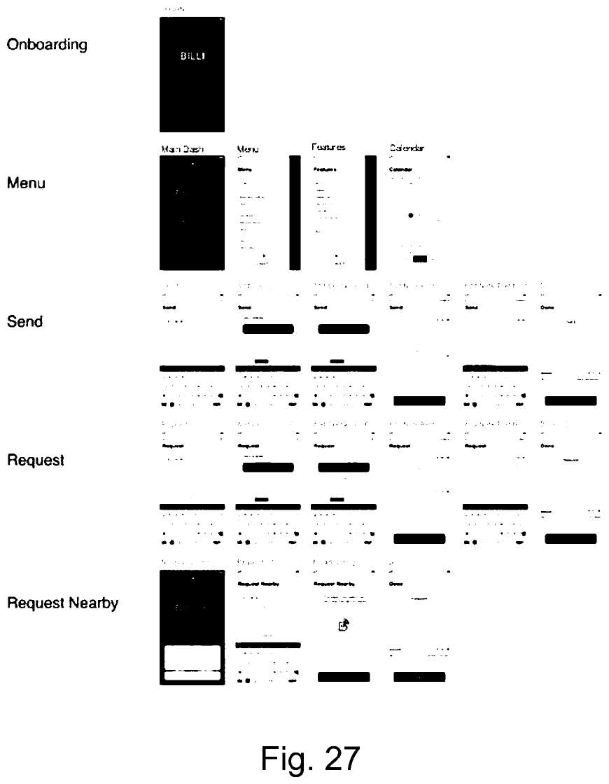

FIG. 26 shows an “offers and rewards scheme” function set in the embodiment of the system 103 of the invention illustrated in FIG. 15. Offers and rewards schemes can be created using a schemes manager module 125 and pushed to the BILLI™ system 103 to set target user groups. These offers and rewards O, R are then viewable and accessible on the displays of the mobile devices by users of the system 103 via the BILLI™ mobile application 16.

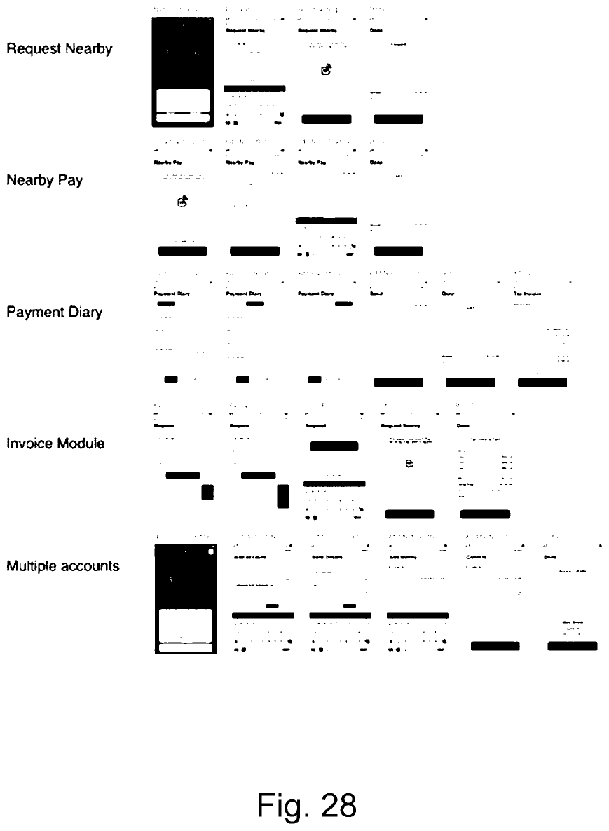

FIGS. 27 and 28 illustrate examples of user interface screens on a display of a user smartphone as it implements the BILLI™ mobile application 16 in the BILLI™ system 102, 103 of the present invention to perform the various functionalities of the system 102, 103 described above. These include “Onboarding” of the user at the login screen, “Menu” screens available from the main dashboard screen, illustrating a selection of menu features and calendar functions, “Send” screens for send functions, “Request” screens for request functions including “Request Nearby” for requesting a peer-to-peer “Nearby Pay” function, “Diary Module” screens for diary functions (e.g. to schedule payments) and “Invoice Module” screens for invoicing functions.

All embodiments of the BILLI™ mobile application 16 can include security protocols for users' protection. To protect a user's data, encryption, steganography and/or the technique of scrambling of a user's data is implemented to ensure safety and identity, privacy and anonymity of Consumer and Business Users with or without utilisation the BILLI™ ID User Cash Card.

### ADVANTAGES AND INDUSTRIAL APPLICABILITY

The embodiments and broader inventive concept provide a number of advantages. Firstly, all bills can be captured and managed by the BILLI™ system 103. In contrast to the current system, existing systems do not capture and manage bills. They typically provide a third party processing of bills portal that enables bills to be entered and paid by a user.

Moreover, the system provides the ability to link the payment of bills in the BILLI™ system 103 to a number of payment methods in the one interface. Existing systems that enable the payment of bills require that a user interacts with a variety of interfaces to pay with a variety of methods. In addition, the system provides the capability to spread the responsibility for a bill over a number of entities. Importantly, the final instruction for transfer of funds from a fund source to a biller may be undertaken by the BILLI™ system, a party separate to the user.

The system, method, and computer program product in accordance with the embodiments described herein can be applicable in any situation where an electronic exchange of funds or value is required.

A part of the BILLI™ system approach is embedded in an ability to react to a user request for payment or transfer with corresponding response, acknowledgement and activation of the request. There are low or negligible money transfer cost with transactional capability worldwide, and the funds transfer is capable of being activated in real time, effectively instantaneous, in all world time zones. The system furthermore offers accessiblity for users via mobile Smartphone, tablet, or other internet-capable computing device, and funds transfers can be conducted without resorting to bank accounts or traditional bank activation procedures.

The processes referred to throughout may be readily conducted or activated cross-border in multi-currency transaction options: day or night; 24/7; within or outside normal banking hours, on weekends and public holidays.

The bills payment technology including software source and object codes and algorithmic calibrations and programming provide the BILLI™ system functionality of: bills retrieval; bills sourcing; bills sorting; sequencing; ordering; prioritising as to timing and/or importance; bills splitting for payment; and multiple transactions setup to go. The BILLI™ system can embrace the “Tap and Go” and twin smartphone or smartphone and tablet “KISS” activation functionality.

The system incorporates by means of encryption, steganography, the technique of scrambling in order to both protect the security, safety and identity, privacy and anonymity of Consumer and Business Users with or without utilisation the BILLI™ ID User Cash Card. The system also provides time savings for users by obviating of the need to contact a bank. The system also provides the opportunity for users to have and to switch between as many personal, family or business accounts as they wish, or as is practicable.

At any time pre- or post-activation of funds transfer, file data detailing the transactions may be exported to relevant professional counsel, family members or others at any time and from any location. Furthermore, the users of any of the above embodiments herein have the opportunity to retrieve data, files, and information from the BILLI™ system and utilise same for budgeting, planning and otherwise organising one's current, medium and long term personal and business operations and activities.

### VARIATIONS AND MODIFICATIONS

Although specific embodiments of the invention are illustrated and described herein, it will be appreciated by persons of ordinary skill in the art that a variety of alternative and/or equivalent implementations exist. It should be appreciated that each exemplary embodiment is an example only and is not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that the terms “comprise”, “comprising”, “include”, “including”, “contain”, “containing”, “have”, “having”, and any variations thereof, used in this document are intended to be understood in an inclusive (i.e. non-exclusive) sense, such that the process, method, device, apparatus, or system described herein is not limited to those features, integers, parts, elements, or steps recited but may include other features, integers, parts, elements, or steps not expressly listed and/or inherent to such process, method, process, method, device, apparatus, or system. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects. In addition, any reference to positional terms, such as “lower” and “upper”, used in the above description are to be taken in context of the embodiments depicted in the figures, and are not to be taken as limiting the invention to the literal interpretation of the term but rather as would be understood by the skilled addressee in the appropriate context.

It will be understood that the embodiments and broader invention described herein are provided via an ‘App’, namely a software application arranged to operate on a mobile device, such as a smartphone. However, the embodiments and broader invention may also be encoded in firmware or integrated into an operating system for a device, as required for any particular use. For example, a dedicated Point of Sale terminal may be utilised to display the QR code in accordance with an embodiment of the invention. The use of hardware devices (as opposed to software devices) may provide particular advantages, such as the ability to better secure communication channels and/or the ability to perform transactions more quickly (which may be important in a busy environment). Such variations are encompassed by the broader inventive concept described herein.

Although not required, the embodiments described with reference to the Figures can be implemented via an application programming interface (API), an application development kit (ADK) or as a series of libraries, for use by a developer, for the creation of software applications which are to be used on any one or more computing platforms or devices, such as a terminal or personal computer operating system or a portable computing device, such as a smartphone or a tablet computing system operating system, or within a larger server structure, such as a ‘data farm’ or within a larger transaction processing system.

Generally, as program modules include routines, programs, objects, components and data files that perform or assist in the performance of particular functions, it will be understood that the functionality of the software application may be distributed across a number of routines, programs, objects or components to achieve the same functionality as the embodiment and the broader invention claimed herein. Such variations and modifications are within the purview of those skilled in the art.

It will also be appreciated that where methods and systems of the present invention and/or embodiments are implemented by computing systems or partly implemented by computing systems then any appropriate computing system architecture may be utilised. This includes standalone computers, network computers and dedicated computing devices (such as field-programmable gate arrays). Where the terms “computer”, “computing system”, “computing infrastructure” and “computing device” are used in the specification, these terms are intended to cover any appropriate arrangement of computer hardware for implementing the inventive concepts and/or the embodiments described herein.

1. A system for managing transfer of funds, and especially for managing payment bills and invoices, by users of the system, the system comprising:
networked computing infrastructure including: a server or processor, and a database of user data including user accounts for access by the respective users, wherein the networked computing infrastructure, especially the server or processor, is configured to receive data relating to one or more bills or invoices associated with each user and to store particulars of each bill or invoice in the respective user account for access by that user; and
at least one user computing device for a user having an account in the database to remotely access and communicate with the networked computing infrastructure;
wherein the networked computing infrastructure, especially the server or processor, is configured to process a payment of a bill or invoice to a respective biller from an account of the user associated with that bill or invoice upon receipt of a payment authorization from the user via the user computing device.

2. The system according to claim 1, wherein each user account is configured to store an amount of funds or value credit in valid currency for payment of bills and invoices by the said user via the networked computing infrastructure, wherein each user account is associated with a third party bank or financial institution account of the user for transfer by the user of funds or value credit into and from the user account in the networked computing infrastructure.

3. The system according to claim 1 or 2, wherein the networked computing infrastructure is configured to enable each user of the system to communicate and interact, and particularly conduct transactions, with any other user of the system via respective user computing devices, especially via mobile user computing devices, and especially where each of those users are individuals or natural persons.

4. The system according to any one of claims 1 to 3, wherein, upon receipt of a command transmitted to the networked computing infrastructure by a first user of the system via a first user computing device, the networked computing infrastructure is configured to notify a second user of the system, via a second user computing device, of a request by the first user to share a bill or invoice with the second user, wherein the request preferably identifies a share proportion of the bill or invoice nominated by the first user, and wherein the request is preferably to be accepted or rejected by the second user.

5. The system according to any one of claims 1 to 4, wherein the networked computing infrastructure is configured to transmit to a second user an invoice issued by the first user to the second user for acceptance or rejection by the second user, upon receipt of a command transmitted to the networked computing infrastructure by a first user via a first user computing device.

6. The system according to any one of claims 1 to 5, wherein the system is configured to effect a transfer funds from a second user to a first user upon receipt of a request from the second user for such a transfer, wherein the transfer of funds is enabled by the networked computing infrastructure when a first user computing device and a second user computing device are within a predefined proximity or distance of one another.

7. The system according to claim 6, wherein the first user computing device and the second user computing device are configured to connect with one another via wireless communication technology when they are within a predefined proximity or distance of one another, the wireless communication technology preferably being Bluetooth, WiFi, or Modulated Acoustic Frequency.

8. The system according to any one of claims 1 to 7, wherein each user computing device is remote from the networked computing infrastructure and comprises a desktop computer, a laptop computer, a tablet device, or a mobile smart-phone; wherein the at least one user computing device is preferably a mobile computing device.

9. The system according to any one of claims 1 to 8, wherein the networked computing infrastructure is configured to receive data relating to one or more bills or invoices through at least one of the following steps:
receiving an image of a bill or invoice, preferably from the at least one user computing device, wherein the data and particulars of the bill or invoice in the image are converted to digital data or text using OCR technology;
accepting a share of a bill or invoice, preferably via a request transmitted using secure information transfer (e.g. NFC reading capabilities to read a NFC chip);
transmitting an electromagnetic or modulated acoustic link between two user computing devices of the system;
manually inputing bill or invoice data at a user computing device of the system; and/or
receiving a copy of a bill or invoice in a digital or electronic format.

10. A system for transfer of funds from a first user to a second user, comprising:
a digital finance architecture including an account of the first user and an account of the second user; and a plurality of mobile computational devices;
wherein the first and second users are engaged with the digital finance architecture via a respective one of the plurality of mobile computational devices;
wherein the mobile computational devices of the first and second users are configured to connect with one another via wireless communication technology if those mobile computational devices are sufficiently proximate one another; and
wherein a transfer of funds is enabled via the digital finance architecture when the mobile computational devices of the first and second user are sufficiently proximate one another.

11. The system according to claim 10, wherein sufficiently proximate is a predefined distance preferably less than or equal to about 15 metres in a direct line, more preferably less than or equal to about 10 metres in a direct line; and wherein the wireless communications technology is selected from one of Bluetooth, Wi-Fi, and Modulated Acoustic Frequency.

12. The system according to claim 10 or claim 11, wherein the location and proximity of the first and second users is calculated using one of GPS, radio frequency, sound reflection, or carrier cellular triangulation.

13. The system according to any one of claims 10 to 12, wherein the first user sends a request to the second user to initiate the transfer of funds, wherein the second user may accept the request and select a payment function to finalise the transfer of funds between the first user and the second user, and wherein the transfer of funds is implemented in real time when the transfer is finalized.

14. The system according to any one of claims 10 to 13, wherein the transfer of funds is only enabled if both the first user and second user are verified as registered users by the digital finance architecture; and/or wherein the digital finance architecture requires two- or three-step verification from the first and second users in order to effect the transfer of funds.

15. The system according to any one of claims 9 to 14, wherein communication between the mobile computational devices and the digital finance architecture is secured, desriably with at least one of steganography, encryption, and/or scrambling.

16. The system according to any one of the preceding claims, further comprising: a computer program product configured for installation and operation on each user computing device or each mobile computational device to communicate and interface with the networked computer infra-structure or the digital finance architecture, wherein the computer program product is configured, when installed and operated on each device, to perform one or more of the following functions or steps:
access a user account in the system;
capture an image of a bill or invoice for conversion to digital data or text; e.g. using OCR, to ascertain particulars of the bill or invoice for storage in a user account in the system;
receive a copy of a bill or invoice in a digital format and automatically extract bill data from the digital format, such as XBRL, to obtain particulars of the bill or invoice for storage in a user account in the system;
provide manual entry of particulars of a bill or invoice for storage in a user account in the system;
display bills and invoices stored in a user account in the system to a respective user; and/or
communicate and interact with any other users of the system, especially where a user is an individual or natural person, then to communicate and interact with any 2^{nd} users of the system, especially 2^{nd} users who are also individuals or natural persons, including:
send a request to a 2^{nd} user to share a bill or invoice, preferably using secure information transmission; and/or
send a notice to a 2^{nd} user regarding a transfer funds to the 2^{nd} user, preferably using secure information transmission; and/or
accept a share of a bill or invoice requested by a 2nd user; and/or
accept a transfer funds notified by a 2^{nd} user; and/or
transmit a link, such as an electromagnetic link or a modulated acoustic link, to another user computing device when the other device is within a predefined proximity or distance.

17. A computer program product configured for installation and operation on a plurality of a user computing devices, especially mobile user computing devices, to communicate and interface with computer infrastructure of a payment management system, the computer infrastructure including: a server or processor, and a database of user data including user accounts for access by respective users, wherein the computer program product, when installed and operated on each user computing device, is configured to perform one or more of the following functions or steps:
access a user account in the payment management system;
capture an image of a bill or invoice for conversion to digital data or text; e.g. using OCR, to ascertain particulars of the bill or invoice for storage in a user account in the system;
receive a copy of a bill or invoice in a digital format and automatically extract bill data from the digital format, such as XBRL, to obtain particulars of the bill or invoice for storage in a user account in the payment management system;
provide manual entry of particulars of a bill or invoice for storage in a user account in the payment management system;
display bills and invoices stored in a user account in the system to a respective user; and/or
communicate and interact with any other users of the system, especially where a user is an individual or natural person, i.e. to communicate and interact with any 2^{nd} users of the system, especially 2^{nd} users who are also individuals or natural persons, including:
send a request to a 2^{nd} user to share a bill or invoice, preferably using secure information transmission; and/or
send a notice to a 2^{nd} user regarding a transfer funds to the 2^{nd} user, preferably using secure information transmission; and/or
accept a share of a bill or invoice requested by a 2nd user; and/or
accept a transfer funds notified by a 2^{nd} user; and/or
connect with another user device via wireless communication technology, such as NFC, Bluetooth, WiFi, or a modulated acoustic frequency, when within a predefined proximity or distance; and/or
transmit a link, such as an electromagnetic link or a modulated acoustic link, to another user computing device when the other device is within a predefined proximity or distance.

18. A method of managing transfers of funds, especially payments of bills and invoices, by one or more users, the method comprising steps of:
maintaining at least one user account for each user of the system in a computing infrastructure, wherein each user account is configured to store an amount of funds or value credit in valid currency for electronic access by the respective users;
receiving data in the computing infrastructure relating to one or more bills or invoices associated with each user and storing particulars of each bill or invoice in the respective user account of the computing infrastructure for access by that user; and
enabling remote access to and communication with the computing infrastructure by each of the users via a user computing device for effecting transfer of funds to and/or from their respective user accounts, especially for payment of bills and invoices;
processing via the computing infrastructure a transfer of funds or a payment of a bill or invoice to a respective biller from an account of a user associated with that bill or invoice upon receipt of an authorization from that user via the user computing device.

19. The method according to claim 18, further comprising a step of enabling transfer of funds or value credit by each user into and from the respective user account in the networked computing via a third-party bank or financial institution account of that user.

20. The method according to claim 18 or 19, further comprising: enabling each user of the system to communicate and interact, and particularly conduct transactions, with any other user of the system via respective user computing devices, especially mobile user computing devices, and especially where each of those users are individuals or natural persons.

21. The method according to any one of claims 18 to 20, further comprising, on receipt of a command sent to the computing infrastructure from a first user via a first user computing device, notifying a second user, via a second user computing device, of a request by the first user to share a bill or invoice with the second user, wherein the request preferably identifies a share proportion of the bill or invoice nominated by the first user, and wherein the request is preferably to be accepted or rejected by the second user.

22. The method according to any one of claims 18 to 21, further comprising, on receipt of a command transmitted to the computing infrastructure by a first user via a first user computing device, transmitting to a second user an invoice issued by the first user to the second user for acceptance or rejection by the second user.

23. The method according to any one of claims 18 to 22, further comprising: effecting a transfer funds from a second user to a first user upon receipt of a request from the second user for such a transfer, when user computing devices of the first and second users are within a predefined proximity or distance of one another.

24. The method according to any one of claims 18 to 23, further comprising connecting the first and second user computing devices with one another via wireless communication technology when they are within the predefined proximity or distance of one another, preferably via WiFi, NFC, Bluetooth, or Modulated Acoustic Frequency.

25. The method according to any one of claims 18 to 24, wherein each user computing device is remote from the computing infrastructure and comprises a laptop computer, a tablet device, or a mobile smart-phone.

26. The method according to any one of claims 18 to 25, wherein the step of receiving data relating to one or more bills or invoices comprises one or more of:
receiving an image of a bill or invoice, preferably from a user computing device, wherein the data and particulars of the bill or invoice in the image are converted to digital data or text using OCR technology;
accepting a share of a bill or invoice, preferably via a request transmitted using secure information transfer (e.g. NFC reading capabilities to read a NFC chip);
transmitting an electromagnetic or modulated acoustic link between two user computing devices of the system;
manually inputting bill or invoice data at a user computing device of the system; and/or
receiving a copy of a bill or invoice in a digital or electronic format.
